(19) United States
(12) Patent Application Publication
(10) Pub. No.: US 2004/0112529 A1
(43) Pub. Date: Jun. 17, 2004

(54) Methods for interfacing macroscale components to microscale devices

(75) Inventors: Mattias Karlsson, Goteborg (SE); Owe Orwar, Hovas (SE); Daniel T. Chiu, Seattle, WA (US)

Correspondence Address: Dianne M. Rees, Ph.D., Edwards & Angell, LLP, P.O. Box 9169, Boston, MA, 02209, US

(73) Assignee: CELLECTRICON AB

(21) Appl. No.: 10/682,310

(22) Filed: Oct. 8, 2003

Related U.S. Application Data
(60) Provisional application No. 60/417,342, filed on Oct. 9, 2002.

(51) Int. Cl. C09J 5/10

(52) U.S. Cl. 156/306.6

(57) ABSTRACT

The invention provides integrated systems comprising macroscale devices interfaced with microscale devices and methods for making these systems.

### RELATED APPLICATIONS

This application claims priority to U.S. Provisional Application Serial No. 60/417,342, filed Oct. 9, 2002, the entirety of which is incorporated herein by reference.

### FIELD OF THE INVENTION

The invention relates to methods for interfacing macroscale components or devices to microscale devices such as microfluidic chips or MEMS devices and to integrated systems comprising macroscale and microscale components.

### BACKGROUND OF THE INVENTION

Microfluidics systems provide ways to manipulate minute volumes of liquid and to miniaturize assays involving the separation and detection of molecules. A microfluidic chip typically comprises a plurality of microchannels through which picoliter-to-nanoliter volumes of solvent, sample, and reagents solutions, progress through narrow tunnels to be mixed, separated, and/or analyzed. Miniaturization increase performance and throughput, offering the potential for high throughput parallel processing. Because microfluidic devices can be designed to conform to microplate design standards, laboratories can work with robotic equipment used for dispensing samples and reagents into microwells of microplates can be adapted for use with these devices. Chips can be stacked to provide multi-dimensional channel networks. Microfluidic devices have applications in the processing and/or analysis of chemical reagents, nucleic acids, proteins, and even cells. bonding materials, and even mechanical connections. Current methods of joining macroscale components to microscale devices are time consuming and can reduce the functionality (e.g., fluid flow) of the microscale device.

### SUMMARY OF THE INVENTION

There is a need in the art for methods of interfacing macroscale components to microscale devices such as microfluidic chips or MEMS devices without reducing the functionality of the device.

The invention provides a method for interfacing a macroscale component or device with a microscale component or device. In one aspect, the method comprises providing a macroscale device, providing a microscale device, providing a double-sided tape comprising a backing with a first and second side, each side coated at least partially with an adhesive to thereby generate a first and second adhesive surface, respectively, adhering the first adhesive surface to a macroscale device surface to be interfaced with a microscale device surface, and contacting the microscale device surface to the second adhesive, thereby interfacing the macroscale device with the microscale device.

Alternatively, the method comprises providing a macroscale device, providing a microscale device, providing a double-sided tape comprising a backing with a first and second side, each side coated at least partially with an adhesive to thereby generate a first and second adhesive surface, respectively, adhering the first adhesive surface to a microscale device surface to be interfaced with a macroscale device surface, and contacting the macroscale device surface to the second adhesive, thereby interfacing the macroscale device with the microscale device.

Preferably, at least one adhesive surface is covered by a release liner prior to adhering the tape to the surface of the macroscale or microscale component/device.

In another aspect, the invention provides a method for interfacing a macroscale device with a microscale device, comprising providing a macroscale device, providing a microscale device, providing a transfer tape comprising a backing to which an adhesive surface is separably attached and wherein the bond between the adhesive and backing is weaker than a bond to formed between the adhesive and a macroscale device surface or microscale device surface, and adhering the adhesive surface to the macroscale device surface. The backing is then removed and the microscale device surface is contacted to the adhesive adhered to the macroscale surface, thereby interfacing the macroscale device with the microscale device.

Alternatively, the method comprises providing a macroscale device, providing a microscale device, providing a transfer tape comprising a backing to which an adhesive surface is separably attached and wherein the bond between the adhesive and backing is weaker than a bond to formed between the adhesive and a macroscale device surface or microscale device surface, and adhering the adhesive surface to the microscale device surface. The backing is removed and the macroscale device is contacted with the adhesive adhered to the microscale surface, thereby interfacing the macroscale device with the microscale device.

Preferably, the backing comprises a release coating for facilitating release of the adhesive from the backing.

The first adhesive and second adhesive can comprise different types of adhesive to render adhesive suitable for adhering to the particular surface of the macroscale or microscale device. In one aspect, at least one surface of the backing comprises portions that are coated with adhesive and portions that are not coated with adhesive.

In one aspect, the microscale device is a microfluidic device or an MEMS device. Preferably, the microfluidic device comprises at least one microchannel. More preferably, the microfluidic device comprises a plurality of microchannels. In another aspect, the microchannels correspond in number to the number of wells in an industry-standard microtiter plate. The microchannels preferably connect to reservoirs in the microfluidic device and wherein the center-to-center distance of each reservoir

In one aspect, the microscale device is a microfluidic device or an MEMS device. Preferably, the microfluidic device comprises at least one microchannel. More preferably, the microfluidic device comprises a plurality of microchannels. In another aspect, the microchannels correspond in number to the number of wells in an industry-standard microtiter plate. The microchannels preferably connect to reservoirs in the microfluidic device and wherein the center-to-center distance of each reservoir corresponds to the center-to-center distance of the wells in the industry-standard microtiter plate.

In a further aspect, the microfluidic device further comprises a sensor chamber for containing a sensor for detecting an analyte or a condition. In one aspect, the sensor is a cell-based biosensor and the sensor chamber is configured to receive one or more cells. In another aspect, the microfluidic device comprises at least one electrical element for performing planar patch clamp analysis.

Suitable macroscale surfaces which can interface with microscale devices using methods according to the invention include, but are not limited to: a surface of a component/device selected from the group consisting of a pump head, pump, degasser, flow meter, injector manifold, a pressure sensor; flow cell; concentration manifold or cartridges; a fitting or connector, a mixer, a compressor, an ultrasonic bed, an extractor, a focusing device, a dialysis chamber, an absorption chamber, a metabolite chamber, a toxicity chamber, a cell chamber, a detector, an RFID tag, a reagent vessel, a separation column, a focusing column, a size exclusion column, an ion-exchange columns; affinity columns; solid-phase extraction beds; a filter; a sieve; a flit; a depth filter, a heater, a heat exchanger, a cooler; a magnetic field generator; electric field generator; electroporation device, patch clamp pipette, a medical device, and one or more connections to any of the above components/devices.

Suitable detectors include, but are not limited to: UV/Visible absorbance flow cell, a fluorescence flow cell, a conductivity flow cell, an electrochemical detector, a plasma detector, a mass spectrometry detector, and a sensor. Sensors include, but are not limited to: a flow meter, a pressure transducer, a temperature sensor, a chemical sensor, a capillary electrophoresis sensor, an acoustic sensor, a color sensor, an optical sensor, a bar code sensor, a photothermal sensor, and a photoacoustic sensor.

In one particularly preferred aspect, the macroscale device comprises a pump head connectable to a pressurized air supply.

The adhesive can be patterned onto the backing to create a pattern of adhesive on the surface of a particular component or device. The tape itself can be cut to a shape which is substantially the same size as the surface of the macroscale device or microscale device to be interfaced. In one aspect, cutting is performed using a die-cutting machine.

Tapes may be selected which conduct heat or which are electrically conducting.

The invention also provides a system comprising a macroscale component/device which is interfaced with a microscale component/device at an interface using double-sided tape or transfer tape. In one aspect, the microscale device is a microfluidic device or an MEMS device.

Preferably, the microfluidic device comprises at least one microchannel. More preferably, the device comprises a plurality of microchannels. In one particularly preferred aspect, the microchannels correspond in number to the number of wells in an industry-standard microtiter plate. The microchannels connect to reservoirs in the microfluidic device and wherein the center-to-center distance of each reservoir corresponds to the center-to-center distance of the wells in the industry-standard microtiter plate.

Preferably, the microfluidic device further comprises a sensor chamber for containing a sensor for detecting an analyte or condition. In one aspect, the sensor comprises a cell-based biosensor. In another aspect, the microfluidic device comprises at least one electrical element for performing planar patch clamp analysis.

Macroscale components/devices can be any of those described above. In a particularly preferred embodiment, the macroscale device of the system comprises a pump head connectable to a pressurized air supply.

When double-sided tapes are used in the system, the adhesives on each side of the double-sided tape can comprise different types of adhesive. The adhesive may be patterned on the tape. When transfer tape is used in the system, the adhesive also may be patterned on the tape, so that an interfacing surface comprises portions coated with adhesive separated by portions which are not coated.

The methods and systems of the invention result in functional interfaces between macroscale and microscale components/devices. Thus, an interface may be able to provide or maintain pressure within the system, provide or conduct electricity or heat, transmit light (in such cases transparent tapes are used), etc. The systems are modular in that more than one macroscale device may be adhered to a microscale device at an interfacing surface. Similarly, multiple microscale devices may be adhered to single macroscale devices or other microscale devices. Other variations are obvious and encompassed within the scope of the invention.

### BRIEF DESCRIPTION OF THE FIGURES

The objects and features of the invention can be better understood with reference to the following detailed description and accompanying drawings. The Figure is not to scale.

FIGS. 1A-D are schematic diagrams illustrating the use of double-sided adhesive tapes to seal a pump head to a microfluidic chip according to one aspect of the invention. FIG. 1A is a perspective view. FIG. 1B and C are side views of an integrated system comprising macroscale and mesoscale components. FIG. 1D is a top view of adhesive tape used for sealing the components.

FIGS. 2A-C show top views of different embodiments of microfluidic chips according to aspects of the invention illustrating exemplary placements of reservoirs for interfacing with 96-well plates. FIG. 2A shows a chip comprising ligand reservoirs (e.g., the reservoirs receive samples of ligands from a 96-well plate). FIG. 2B shows a chip comprising alternating or interdigitating ligand and buffer reservoirs (e.g., every other reservoir receives samples of ligands from one 96-well plate, while the remaining reservoirs receive samples of buffer from another 96-well plate). As shown in FIG. 2C, additional reservoirs can be placed on chip for the storage and transfer of cells or other samples of interest.

FIGS. 3A-C comprise a top view of a microfluidic chip structure for HTS of drugs according to one aspect of the invention, for scanning a sensor such as a patch-clamped cell or cells across interdigitated ligand and buffer streams. FIG. 3A depicts the overall chip structure for both a 2D and 3D microfluidic system. FIG. 3B shows an enlarged view of the reservoirs of the chip and their individual connecting channels. FIG. 3C shows an enlarged view of interdigitating microchannel whose outlets intersect with the sensor chamber of the chip.

FIG. 4 is a perspective view of a kit in accordance with one aspect of the invention illustrating a process for dispensing fluids from 96-well plates onto a microfluidic chip comprising interdigitating reservoirs using automated array pipettors and cell delivery using a pipette.

FIGS. 5A-C comprise a top view of a microfluidic chip structure for HTS of drugs according to one aspect of the invention, for scanning a sensor such as a patch-clamped cell or cells across interdigitated ligand and buffer streams. FIG. 5A depicts the overall chip structure for both a 2D and 3D microfluidic system. FIG. 5B shows an enlarged view of the reservoirs of the chip and their individual connecting channels. FIG. 5C shows an enlarged view of interdigitating microchannel whose outlets intersect with the sensor chamber of the chip.

FIGS. 6A -N are schematics showing chip designs for carrying out cell scanning across ligand streams using buffer superfusion to provide a periodically resensitized sensor. FIG. 6A is a perspective view of the overall chip design and microfluidic system. FIGS. 6B-G show enlarged views of the outlets of microchannels and their positions with respect to a superfusion capillary and a patch clamp pipette, as well as a procedure for carrying out cell superfusion while scanning a patch-clamped cell across different fluid streams. “P” indicates a source of pressure on fluid in a microchannel or capillary. Bold arrows indicate direction of movement. FIGS. 6H-6N show a different embodiment for superfusing cells. As shown in the perspective view in FIG. 6H, instead of providing capillaries for delivering buffer, a number of small microchannels placed at each of the outlets of the ligand delivery channels are used for buffer delivery. As a patch-clamped cell is moved to a ligand channel and the system detects a response, a pulse of buffer can be delivered via the small microchannels onto the cell for superfusion. The advantage to using this system is that the exposure time of the patch-clamped cell to a ligand can be precisely controlled by varying the delay time between signal detection and buffer superfusion. FIG. 6I is a cross-section through the side of a microfluidic system used in this way showing proximity of a patch-clamped cell to both ligand and buffer outlets. FIG. 6J is a cross section, front view of the system, showing flow of buffer streams. FIG. 6K is a cross-section through a top view of the device showing flow of ligand streams and placement of the buffer microchannels. FIGS. 6L-7M show use of pressure applied to a ligand and/or buffer channel to expose a patch clamped cell to ligand and then buffer.

FIGS. 7A-C are top views showing a microfluidic chip for carrying out rapid and sequential exchange of fluids around a patch-clamped cell. FIG. 7A shows the overall arrangement of channels feeding into, and draining from, a cell chamber. The drain channels feed into a plurality of reservoirs such that the pressure drops across each channel can be independently controlled. FIG. 7B shows an enlarged view of reservoirs and their connecting channels. FIG. 7C shows an enlarged view of microchannel outlets which feed into the cell chamber.

FIG. 8 is an enlarged illustration of FIG. 7A, depicting the arrangement of and flow directions of fluids in microchannels around a cell chamber with a patch-clamped cell in a planar 2D microfluidic system according to one aspect of the invention.

FIGS. 9A-C are top views depicting the chip structure of a fishbone design for carrying out rapid and sequential exchange of fluids around a patch-clamped cell (not shown) according to one aspect of the invention. In the example shown in FIG. 9A, a single drain channel is provided which feeds into a single waste reservoir. FIG. 9B shows an enlarged view of reservoirs for providing sample to the microchannels. FIG. 9C shows an enlarged view of a plurality of inlet channels intersecting with a central “spine” channel which feeds sample into the sensor chamber. In this enlarged view, intersecting channels are perpendicular to the spine channel rather than slanted; either configuration is possible.

FIG. 10 is a schematic illustration of an enlarged view of FIG. 9A depicting arrangements of, and flow directions in, microchannels, and a patch-clamped cell in a chip according to one aspect of the invention, as well as the presence of passive one-way valves, which are schematically depicted as crosses.

### DETAILED DESCRIPTION

The invention provides integrated systems comprising macroscale devices interfaced with microscale devices and methods for making these systems.

Definitions

The following definitions are provided for specific terms which are used in the following written description.

As used in the specification and claims, the singular form “a”, “an” and “the” include plural references unless the context clearly dictates otherwise. For example, the term “a cell” includes a plurality of cells, including mixtures thereof.

As used herein, a “macroscale component” is a component which is at least about 1 mm in all three dimensions. Although in some aspects, macroscale components are greater than about 10 mm, greater than about 50 mm, greater than about 100, 200, 300, 400, 500, 600, 700 mm or even greater than 1 cm in all three dimensions.

As used herein, the terms “microscale,” “microfabricated” or “microfluidic” refers to a substrate which is less than about 1 mm in all three dimensions and preferably is less than about 500 μm in all three dimensions.

As used herein, a “polymer” refers to macromolecular materials having at least five repeating monomeric units, which may or may not be the same. The term” “polymer”, as used herein, encompasses homopolymers and copolymers. Copolymers of the invention refer to those polymers derived from at least two chemically different monomers.

As used herein, “a pressure sensitive adhesive” refers to any form of adhesive that has pressure sensitive properties at the time of application to a supporting structure. As identified by the Pressure Sensitive Tape Council, a pressure sensitive adhesive requires firm adhesion to a variety of dissimilar surfaces upon mere contact without the need of more than finger or hand pressure.

As used herein, “transfer tape” means a pre-constructed article consisting of an adhesive layer releasably attached to a release liner, the adhesive layer can be transferred to a substrate from the release liner thereby establishing opposing adhesive surfaces.

As used herein, a “biosensor” refers to a device comprising one or more molecules capable of producing a measurable response upon interacting with a condition in an aqueous environment to which the molecule is exposed (e.g., such as the presence of a compound which binds to the one or more molecules). In one aspect, the molecule(s) are immobilized on a substrate, while in another aspect, the molecule(s) are part of a cell (e.g., the sensor is a “cell-based biosensor”). Preferably, a sensor comprises a substrate comprising a cell chamber for receiving one or more cells.

As used herein, a “microchannel” refers to a groove in a substrate comprising two walls, a base, at least one inlet and at least one outlet. In one aspect, a microchannel also has a roof. The term “micro” does not imply a lower limit on size, and the term “microchannel” is generally used interchangeably with “channel”. Preferably, a microchannel ranges in size from about 0.1 μm to about 1000 μm, more preferably ranging from, 1 μm to about 150 μm.

As used herein, a “cell chamber” or a “measurement chamber” refers to an area formed by walls (which may or may not have openings) surrounding a base. A chamber may be “open volume” (e.g., uncovered) or “closed volume” (e.g., covered by a coverslip, for example) and comprises outlets in one or more walls from at least one microchannel. It is not intended that the geometry of the cell chamber be a limiting aspect of the invention. One or more of the wall(s) and/or base can be optically transmissive. Generally, a measurement chamber ranges in size but is at least about 1 μm. In one aspect, the dimensions of the chamber are at least large enough to receive at least a single cell, such as a mammalian cell. The chamber also can be a separate entity from the substrate comprising the microchannels. For example, in one aspect, the measurement chamber is a petrie dish and the microchannels extend to a surface of the substrate opening into the petrie dish so as to enable fluid communication between the microchannels and the petrie dish.

As used herein, the term “receptor” refers to a macromolecule capable of specifically interacting with a ligand molecule. Receptors may be associated with lipid bilayer membranes, such as cellular, golgi, or nuclear membranes, or may be present as free or associated molecules in a cell's cytoplasm or may be immobilized on a substrate. A cell-based biosensor comprising a receptor can comprise a receptor normally expressed by the cell or can comprise a receptor which is non-native or recombinantly expressed (e.g., such as in transfected cells or oocytes).

As used herein, “periodically resensitized” or “periodically responsive” refers to an ion-channel that is maintained in a closed (i.e., ligand responsive) position when it is scanned across microchannel outlets providing samples suspected or known to comprise a ligand. For example, in one aspect, a receptor or ion-channel is periodically resensitized by scanning it across a plurality of interdigitating channels providing alternating streams of sample and buffer. The rate at which the receptor/ion channel is scanned across the interdigitating channels is used to maintain the receptor/ion-channel in a ligand-responsive state when it is exposed to a fluid stream comprising sample. Additionally, or alternatively, the receptor/ion channel can be maintained in a periodically resensitized state by providing pulses of buffer, e.g., using one or more superfusion capillaries, to the ion channel, or by providing rapid exchange of solutions in a measurement chamber comprising the ion channel.

As used herein, the term “substantially separate aqueous streams” refers to collimated streams with laminar flow.

As used herein, the term “in communication with” refers to the ability of a system or component of a system to receive input data from another system or component of a system and to provide an output response in response to the input data. “Output” may be in the form of data, or may be in the form of an action taken by the system or component of the system. For example, a processor “in communication with a scanning mechanism” sends program instructions in the form of signals to the scanning mechanism to control various scanning parameters as described above. A “detector in communication with a measurement chamber” refers to a detector in sufficient optical proximity to the measurement chamber to receive optical signals (e.g., light) from the measurement chamber. A “light source in optical communication” with a chamber refers to a light source in sufficient proximity to the chamber to create a light path from the chamber to a system detector so that optical properties of the chamber or objects contained therein can be detected by the detector.

As used herein, “a measurable response” refers to a response that differs significantly from background as determined using controls appropriate for a given technique.

As used herein, an outlet “intersecting with” a chamber or microchamber refers to an outlet that opens or feeds into a wall or base or top of the chamber or microchamber or into a fluid volume contained by the chamber or microchamber.

As used herein, “superfuse” refers to washing the external surface of an object or sensor (e.g., such as a cell).

Microscale Components

Microfluidic Devices

In one aspect, a microscale component is a microfluidic device. Preferably, a microfluidic device a substantially planar substrate comprising a least one microchannel and a portion for interfacing with a macroscale component. In the devices of the present invention, the microscale channels preferably have at least one cross-sectional dimension between about 0.1 μm and 200 μm, more preferably between about 0.1 μm and 100 μm, and often between about 0.1 μm and 20 μm. Accordingly, the microfluidic devices or systems prepared in accordance with the present invention typically include at least one microscale channel, usually at least two microscale channels, and often, three or more i channels disposed within a single body structure. Channel intersections may exist in a number of formats, including cross intersections, “T” intersections, or any number of other structures whereby at least two channels are in fluid communication.

In one aspect, the system provides a substrate comprising a plurality of microchannels fabricated thereon whose outlets intersect with, or feed into, a sensor chamber comprising one or more sensors. The system further comprises a scanning mechanism for programmably altering the position of the microchannels relative to the one or more sensors and a detector for monitoring the response of the sensor to exposure to solutions from the different channels. In a preferred aspect, the sensor chamber comprises a cell-based biosensor in electrical communication with an electrode and the detector detects changes in electrical properties of the cell-based biosensor.

The sensor chamber, or at least a portion of a microchannel or reservoir on the chip, may be adapted for performing analytical assays such as fluorogenic assays, mobility shift assays, fluorescence polarization assays, and the like. For example, the microfluidic device can be adapted for DNA sample processing and single nucleotide polymorphism (SNP) detection, immunoassays, toxicology testing, gene expression analysis, and proteomics. Various functions can be performed at the sensor chamber, microchannel or reservoir, including but not limited to mixing, lysing, amplification, and detection. The device therefore can include such microscopic functionalities as mixers, sippers, dispensers, incubators, and separators.

The system preferably also comprises a processor for implementing system operations including, but not limited to: controlling the rate of scanning by the scanning mechanism (e.g., mechanically or through programmable pressure drops across microchannels), controlling fluid flow through one or more channels of the substrate, controlling the operation of valves and switches that are present for directing fluid flow, recording sensor responses detected by the detector, and evaluating and displaying data relating to sensor responses. Preferably, the system also comprises a user device in communication with the system processor which comprises a graphical interface for displaying operations of the system and for altering system parameters.

The Substrate

In a preferred aspect, the system comprises a substrate that delivers solutions to one or more sensors at least partially contained within a sensor chamber. The substrate can be configured as a two-dimensional (2D) or three-dimensional (3D) structure, as described further below. The substrate, whether 2D or 3D, generally comprises a plurality of microchannels whose outlets intersect with a sensor chamber that receives the one or more sensors. The base of the sensor chamber can be optically transmissive to enable collection of optical data from the one or more sensors placed in the sensor chamber. When the top of the sensor chamber is covered, e.g., by a coverslip or overlying substrate, the top of the chamber is preferably optically transmissive.

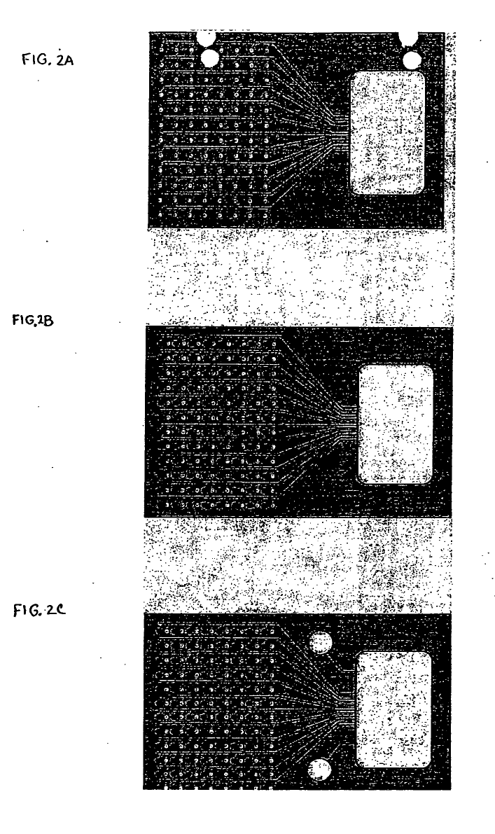

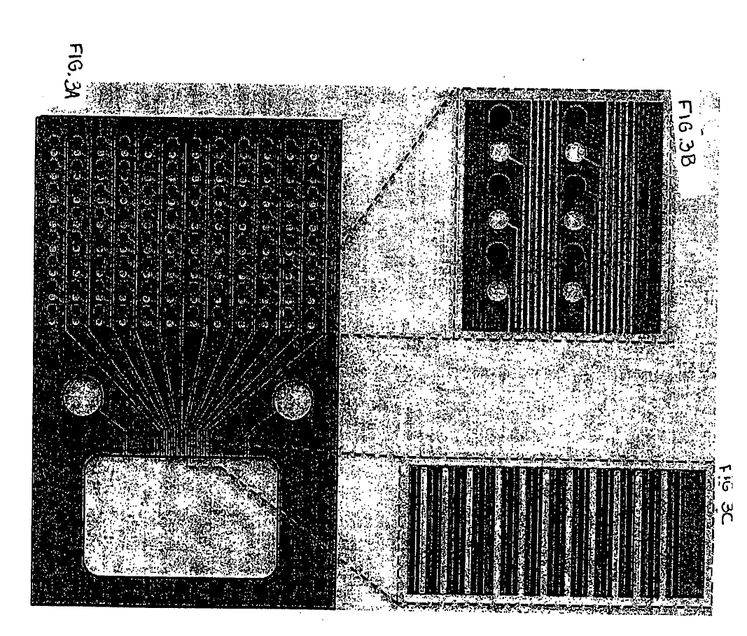

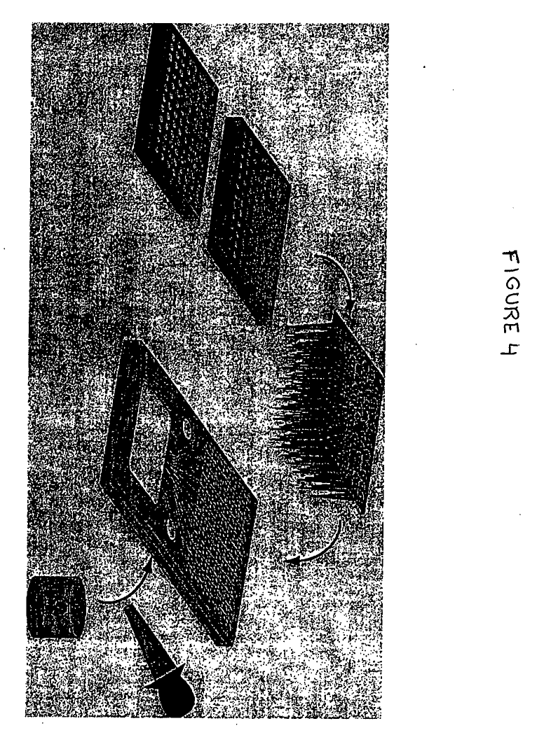

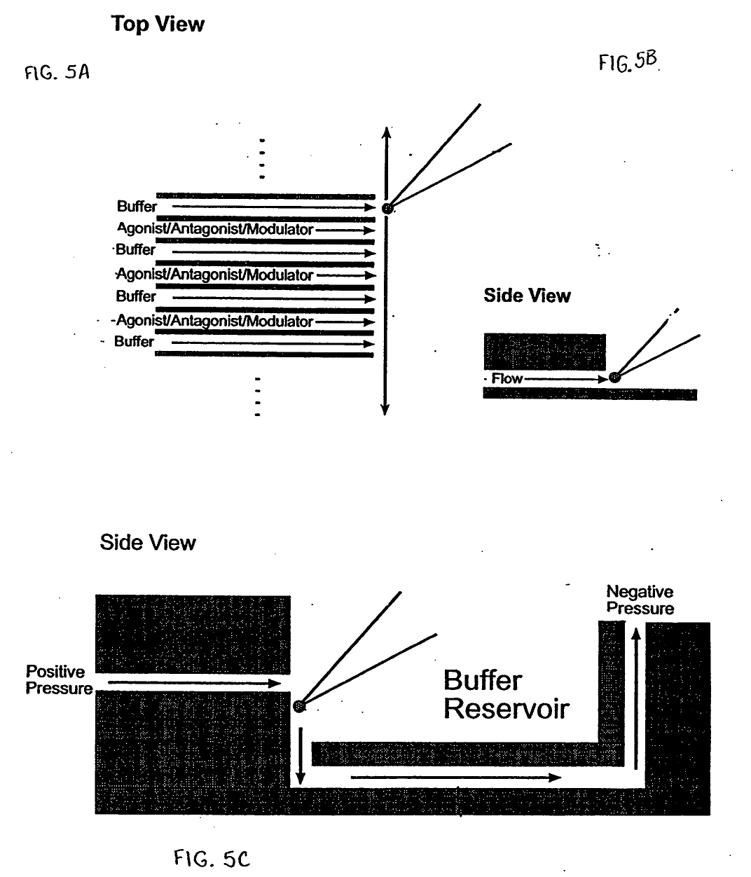

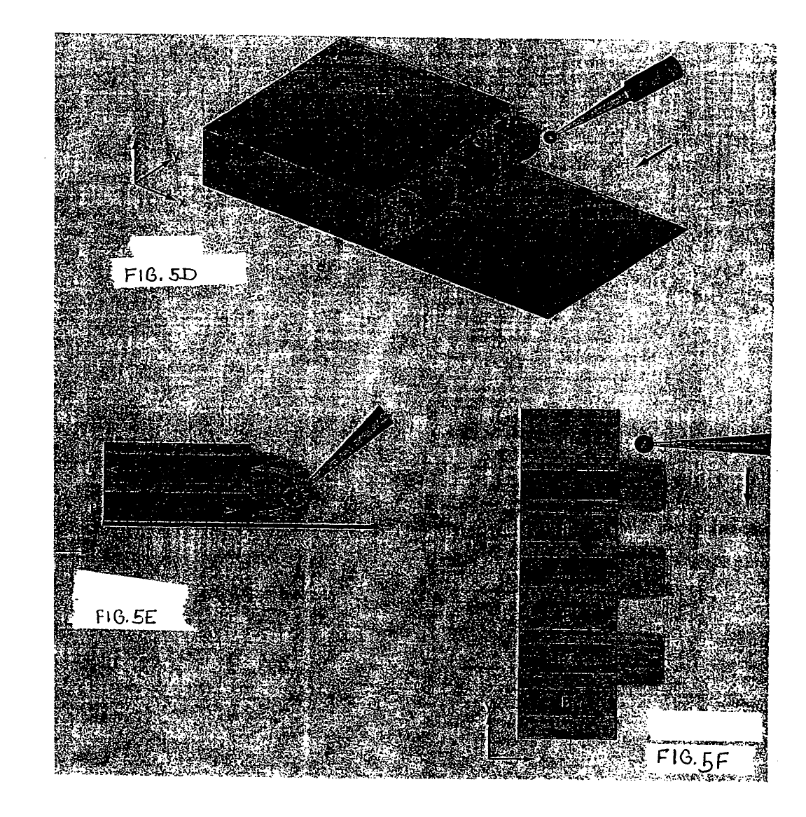

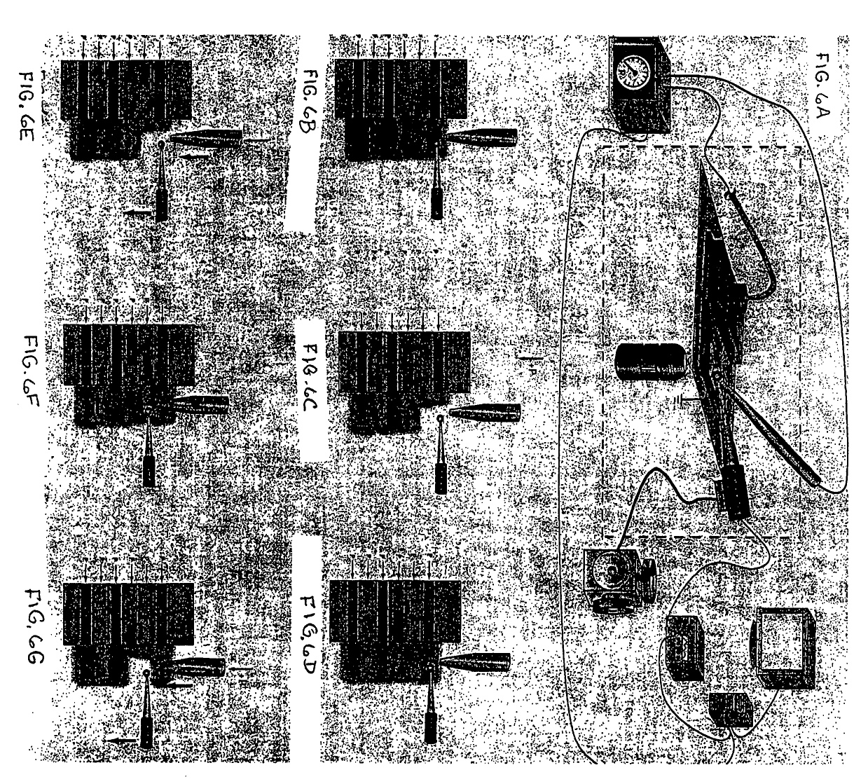

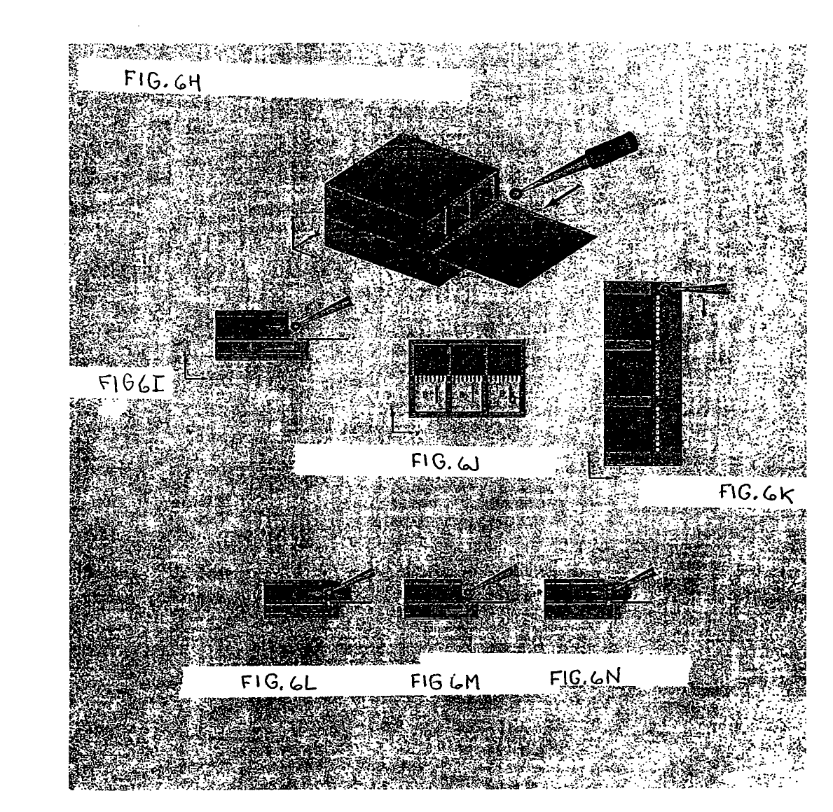

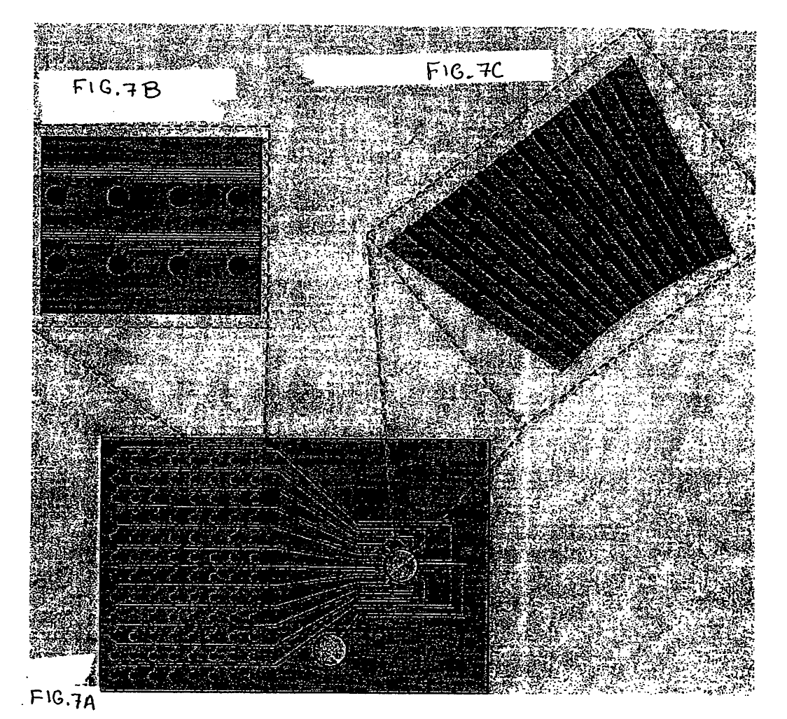

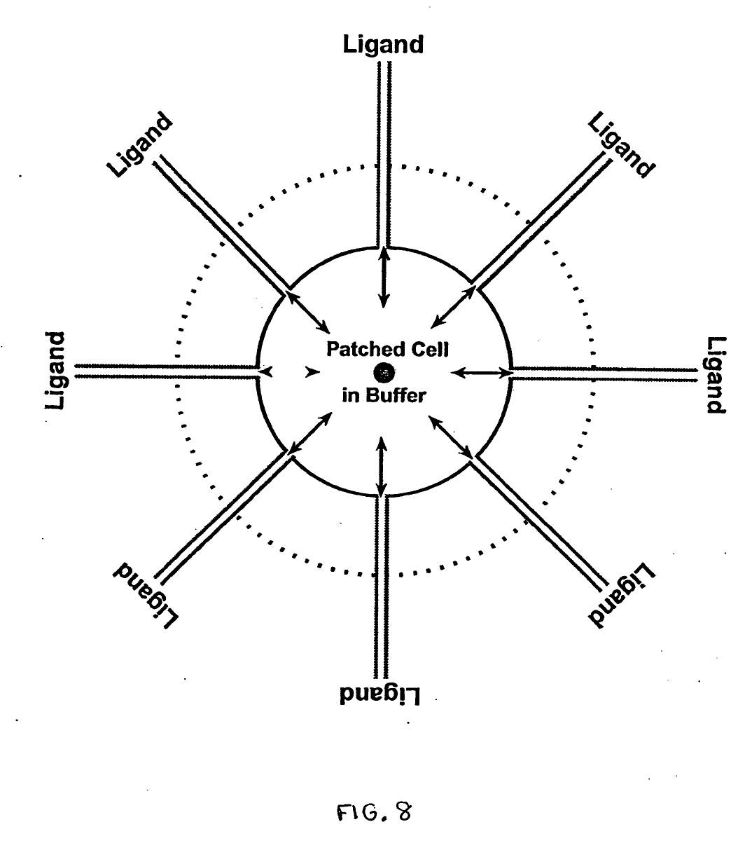

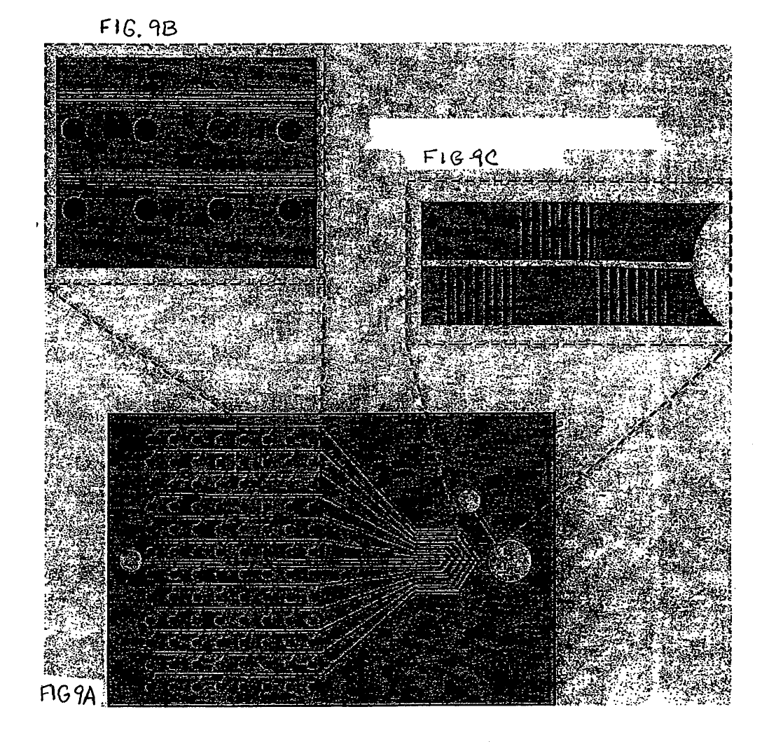

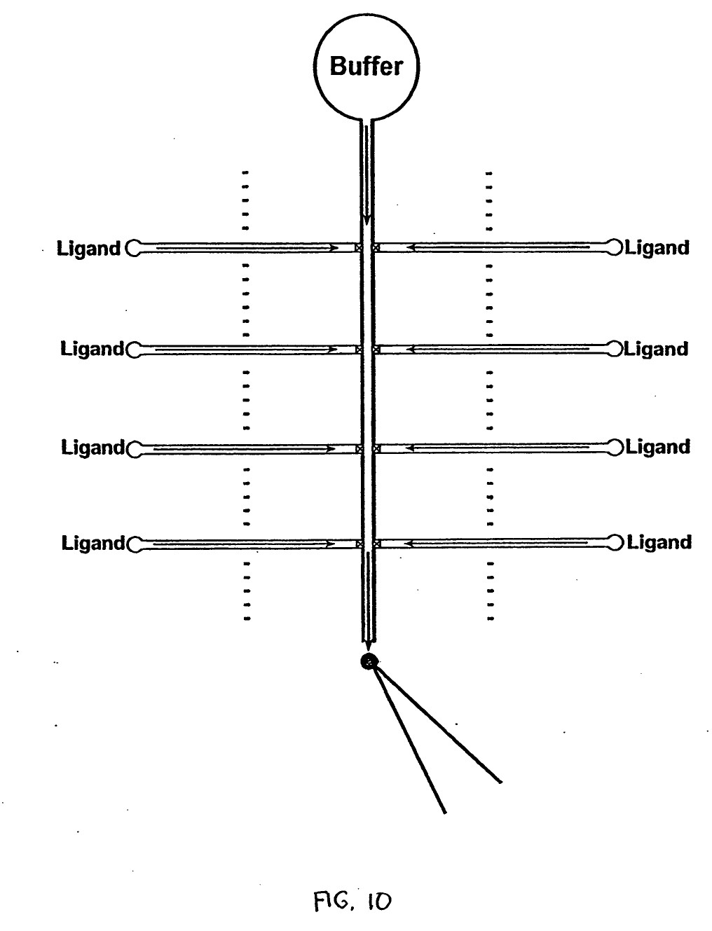

Each microchannel comprises at least one inlet (e.g., for receiving a sample or a buffer). Preferably, the inlets receive solution from reservoirs (e.g., shown as circles in FIGS. 2A and B) that conform in geometry and placement on the substrate to the geometry and placement of wells in an industry-standard microtiter plate. The substrate is a removable component of the system and therefore, in one aspect, the invention provides kits comprising one or more substrates for use in the system, providing a user with the option of choosing among different channel geometries.

Typically, because the devices are microfabricated, substrate materials will be selected based upon their compatibility with known microfabrication techniques, e.g., photolithography, wet chemical etching, laser ablation, reactive ion etching (RIE), air abrasion techniques, injection molding, LIGA methods, metal electroforming, embossing, and other techniques. Suitable substrate materials are also generally selected for their compatibility with the full range of conditions to which the microfluidic devices may be exposed, including extremes of pH, temperature, salt concentration, and application of electric fields. Accordingly, in some preferred aspects, the substrate material may include materials normally associated with the semiconductor industry in which such microfabrication techniques are regularly employed, including, e.g., silica based substrates, such as glass, quartz, silicon or polysilicon, as well as other substrate materials, such as gallium arsenide and the like. In the case of semiconductive materials, it will often be desirable to provide an insulating coating or layer, e.g., silicon oxide, over the substrate material, and particularly in those applications where electric fields are to be applied to the device or its contents. In preferred aspects, the substrates used to fabricate the body structure are silica-based, and more preferably glass or quartz, due to their inertness to the conditions described above, as well as the ease with which they are microfabricated.

Non-limiting examples of different substrate materials include crystalline semiconductor materials (e.g., silicon, silicon nitride, Ge, GaAs), metals (e.g., Al, Ni), glass, quartz, crystalline insulators, ceramics, polymers (e.g., a fluoropolymer, such as Teflon®, polymethylmethacrylate, polydimethylsiloxane, polyethylene, polypropylene, polybutylene, polymethylpentene, polystyrene, polyurethane, polyvinyl chloride, polyarylate, polyarylsulfone, polycaprolactone, polycarbonate, polyestercarbonate, polyimide, polyketone, polyphenylsulfone, polyphthalamide, polysulfone, polyamide, polyester, epoxy polymers, ABS (acrylonitrilebutadiene-styrene copolymer), thermoplastics, and the like), other organic and inorganic materials, and combinations thereof.

In certain aspects, it is desirable to provide a substrate comprising an array of electrodes, e.g., to perform arrayed patch clamping. Microfabrication techniques are ideal for producing very large arrays of electrode devices. For example, electrode devices comprising nanotips can be manufactured by direct processing of a conducting solid-state material. Suitable solid-state materials include, but are not limited to, carbon materials, indium tin oxide, iridium oxide, nickel, platinum, silver, or gold, other metals and metal alloys, solid conducting polymers or metallized carbon fibers, in addition to other solid state materials with suitable electrical and mechanical properties. In one aspect, the substrate comprises an electrically conductive carbon material, such as basal plane carbon, pyrolytic graphite (BPG), or glassy carbon.

Arrays also can be constructed on a doped semiconductor substrate by nanolithography using scanning STM or AFM probes. For example, metal clusters can be deposited either from a solution or by field evaporation from a Scanning Tunneling Microscope/Atomic Force Microscope (STM/AFM) tip onto such a substrate. The surface of the semiconductor can be oxidized so that substantially all of the surface is insulated except for tips protruding from the surface which are in contact with cells, thus minimizing electrode noise. Electrode devices may also be fabricated by chemical etching, vapor deposition processes, lithography and the like.

Polymeric substrates are readily manufactured using available microfabrication techniques, as described above, or from microfabricated masters, using well known molding techniques, such as injection molding, embossing or stamping, or by polymerizing the polymeric precursor material within the mold (see, e.g., U.S. Pat. No. 5,512,131). Polymeric materials may include treated surfaces, e.g., derivatized or coated surfaces, to enhance their utility in the microfluidic system, e.g., to provide enhanced fluid direction (see, e.g., as described in U.S. Pat. No. 5,885,470).

Microchannels can be fabricated on these substrates using methods routine in the art, such as deep reactive ion etching. Channel width can vary depending upon the application, as described further below, and generally ranges from about 0.1 μm to about 500 μm, preferably, from about 1 82 m to about 150 μm, while the dimensions of the sensor chamber generally will vary depending on the arrangement of channel outlets feeding into the chamber. For example, where the outlets are substantially parallel to one another (e.g., as in FIGS. 2A-C), the length of the longitudinal axis of the chamber is at least the sum of the widths of the outlets which feed into the chamber. In one aspect, where a whole cell biosensor is used as a sensor in the sensor chamber, the width of one or more outlets of the microchannels is at least about the diameter of the cell. Preferably, the width of each of the outlets is at least about the diameter of the cell.

In one aspect, a cover layer of an optically transmissive material, such as glass, can be bonded to a substrate, using methods routine in the art, preferably leaving openings over the reservoirs and over the sensor chamber when interfaced with a traditional micropipette-based patch clamp detection system. Preferably, the base of the sensor chamber also is optically transmissive, to facilitate the collection of optical data from the sensor.

The body structure of the microfluidic devices described herein can take a variety of shapes and/or conformations, provided the body structure includes at least one microfluidic channel element disposed within it. For example, in some cases the body structure has a tubular conformation, e.g., a in capillary structure. Alternatively, body structures may incorporate non-uniform shapes and/or conformations, depending upon the application for which the device is to be used. In preferred aspects, the body structure of the microfluidic devices incorporates a planar or “chip” structure. In another aspect, discussed further below, the body structure comprises a “spokes-wheel” configuration.

Integrating Sensors with Microfluidic Devices

Cell-Based Biosensors

In one aspect, the invention provides a microfluidic system that can be used in conjunction with a cell-based biosensor to monitor a variety of cellular responses. The biosensor can comprise a whole cell or a portion thereof (e.g., a cell membrane patch) which is positioned in a sensor chamber using a micropositioner (which may be stationary or movable) such as a pipette, capillary, column, or optical tweezer, or by controlling flow or surface tension, thereby exposing the cell-based biosensor to solution in the chamber. The biosensor can be scanned across the various channels of the substrate by moving the substrate, i.e., changing the position of the channels relative to the biosensor, or by moving the cell (e.g., by scanning the micropositioner or by changing flow and/or surface tension).

In one aspect, the cell-based biosensor comprises an ion channel and the system is used to monitor ion channel activity. Suitable ion channels include ion channels gated by voltage, ligands, internal calcium, other proteins, membrane stretching (e.g., lateral membrane tension) and phosphorylation (see e.g., as described in Hille B., In Ion Channels of Excitable Membranes 1992, Sinauer, Sunderland, Mass., USA). In another aspect, the ion-gated channel is a voltage-gated channel, a ligand-gated channel, a channel gated by a protein, a channel gated by phosphorylation, or a channel gated by a mechanical trigger.

In another aspect, the cell-based biosensor comprises a receptor, preferably, a receptor involved in a signal transduction pathway. For example, the cell-based biosensor can comprise a G Protein Coupled Receptor or GPCR, glutamate receptor, a metabotropic receptor, a hematopoietic receptor, or a tyrosine kinase receptor. Biosensors expressing recombinant receptors also can be designed to be sensitive to drugs which may inhibit or modulate the development of a disease.

Suitable cells which comprise biosensors include, but are not limited to: neurons; lymphocytes; macrophages; microglia; cardiac cells; liver cells; smooth muscle cells; and skeletal muscle cells. In one aspect, mammalian cells are used; these can include cultured cells such as Chinese Hamster Ovary Cells (CHO) cells, NIH-3T3, and HEK-293 cells and can express recombinant molecules (e.g., recombinant receptors and/or ion channels). However, bacterial cells (E. coli, Bacillus sp., Staphylococcus aureus, and the like), protist cells, yeast cells, plant cells, insect and other invertebrate cells, avian cells, amphibian cells, and oocytes, also can be used, as these are well suited to the expression of recombinant molecules. Cells generally are prepared using cell culture techniques as are know in the art, from cell culture lines, or from dissected tissues after one or more rounds of purification (e.g., by flow cytometry, panning, magnetic sorting, and the like).

Non-Cellular Sensors

In one aspect, the sensor comprises a sensing element, preferably, a molecule which is cellular target (e.g., an intracellular receptor, enzyme, signalling protein, an extra cellular protein, a membrane protein, a nucleic acid, a lipid molecule, etc.), which is immobilized on a substrate. The substrate can be the base of the sensor chamber itself, or can be a substrate placed on the base of the chamber, or can be a substrate which is stably positioned in the chamber (e.g., via a micropositioner) and which is moveable or stationary.

The sensor may consist of one or several layers that can include any combination of: a solid substrate; one or more attachment layers that bind to the substrate, and a sensing molecule for sensing compounds introduced into the sensor chamber from one or more channel outlets. Suitable sensors according to the invention, include, but are not limited to, immunosensors, affinity sensors and ligand binding sensors, each of which can respond to the presence of binding partners by generating a measurable response, such as a specific mass change, an electrochemical reaction, or the generation of an optical signal (e.g., fluorescence, or a change in the optical spectrum of the sensing molecule). Such sensors are described in U.S. Pat. No. 6,331,244, for example, the entirety of which is incorporated by reference herein.

In one aspect, the sensor comprises a microelectrode which is modified with a molecule which transports electrons. In response to a chemical reaction caused by contact with one or more compounds in an aqueous stream from one of the microchannels, the molecule will produce a change in an electrical property at the electrode surface. For example, the molecule can comprise an electron-transporting enzyme or a molecule which transduces signals by reduction or oxidation of molecules with which it interacts (see, e.g., as described in, Gregg, et al., 1991, J. Phys. Chem. 95: 5970-5975, 1991; Heller, 1990, Acc. Chem. Res. 23(5): 128-134;Chap, 1994, In Diagnostic Biosensor Polymers. ACS Symposium Series. 556; Usmani, A M, Akinal, N; eds. American Chemical Society; Washington, D.C.; pp. 47-70; U.S. Pat. No. 5,262,035). Enzymatic reactions also can be performed using field-effect-transistors (FETs) or ion-sensitive field effect transistors (ISFETs).

In another aspect, the sensor comprises a sensing molecule immobilized on a solid substrate such as a quartz chip in communication with an electronic component. The electronic component can be selected to measure changes in any of: voltage, current, light, sound, temperature, or mass, as a measure of interaction between the sensing element and one or more compounds delivered to the sensor chamber (see, as described in, Hall, 1988, Int. J. Biochem. 20(4): 357-62; U.S. Pat. No. 4,721,677; U.S. Pat. No. 4,680,268; U.S. Pat. No. 4,614,714; U.S. Pat. No. 6,879,11). For example, in one aspect, the sensor comprises an acoustic wave biosensor or a quartz crystal microbalance, on which a sensor element is bound. In this embodiment, the system detects changes in the resonant properties of the sensor upon binding of compounds in aqueous streams delivered from the microchannels to the sensor element.

In another aspect, the sensor comprises an optical biosensor. Optical biosensors can rely on detection principles such as surface plasmon resonance, total internal reflection fluorescence (TIRF), critical angle refractometry, Brewster Angle microscopy, optical waveguide lightmode spectroscopy (OWLS), surface charge measurements, and evanescent wave ellipsometry, and are known in the art (see, for example, U.S. Pat. No. 5,313,264; EP-A1-0 067 921; EP-A1-0 278 577; Kronick, et al., 1975, J. Immunol. Meth. 8: 235-240).

For example, for a sensor employing evanescent wave ellipsometry, the optical response related to the binding of a compound to a sensing molecule is measured as a change in the state of polarization of elliptically polarized light upon reflection. The state of polarization is related to the refractive index, thickness, and surface concentration of a bound sample at the sensing surface (e.g., the substrate comprising the sensing element). In TIRF, the intensity and wavelength of radiation emitted from either natively fluorescent or fluorescence-labelled sample molecules at a sensor is measured. Evanescent wave excitation scattered light techniques rely on measuring the intensity of radiation scattered at a sensor surface due to the interaction of light with sensing molecules (with or without bound compounds). Surface plasmon resonance (SPR) measures changes in the refractive index of a layer of sensor molecules close to a thin metal film substrate (see, e.g., Liedberg, et al., 1983, Sensors and Actuators 4: 299;GB 2 197 068). Each of these sensing schemes can be used to provide useful sensors according to the invention.

In yet another aspect, the sensor comprises a sensing molecule associated with a fluorescent semiconductor nanocrystal or a Quantum Dot™ particle. The Quantum Dot particle has a characteristic spectral emission which relates to its composition and particle size. Binding of a compound to the sensing element can be detected by monitoring the emission of the Quantum Dot particle (e.g., spectroscopically) (see, e.g., U.S. Pat. No. 6,306,610).

The sensor further can comprise a polymer-based biosensor whose physical properties change when a compound binds to a sensing element on the polymer. For example, binding can be manifested as a change in volume (such as swelling or shrinkage), a change in electric properties (such as a change in voltage or current or resonance) or in optical properties (such as modulation of transmission efficiency or a change in fluorescence intensity).

Cell Treatment Chambers

In one aspect, the chip provides one or more cell treatment chambers for performing one or more of: electroporation, electroinjection, and/or electrofusion. Chemicals and/or molecules can be introduced into a cell within a chamber which is in electrical communication with a source of current. For example, one or more electrodes may be placed in proximity to the chamber, or the chamber can be configured to receive an electrolyte solution through which current can be transmitted, for example, from an electrode/capillary array as described in WO 99/24110, the entirety of which is incorporated by reference herein.

Suitable molecules which can be introduced into a cell in the cell treatment chamber include, but are not limited to: nucleic acids (including gene fragments, cDNAs, antisense molecules, ribozymes, and aptamers); antibodies; proteins; polypeptides; peptides; analogs; drugs; and modified forms thereof. In a preferred aspect, the system processor controls both the delivery of molecules to the one or more cell treatment chambers (e.g., via capillary arrays as described above) and incubation conditions (e.g., time, temperature, etc.). For example, a cell can be incubated for suitable periods of times until a desired biological activity is manifested, such as transcription of an mRNA; expression of a protein; inactivation of a gene, mRNA, and/or protein; chemical tagging of a nucleic acid or protein; modification or processing of a nucleic acid or protein; inactivation of a pathway or toxin; and/or expression of a phenotype (e.g., such as a change in morphology).

The treated cells can be used to deliver molecules of interest to the sensor in the sensor chamber, e.g., exposing the sensor to secreted molecules or molecules expressed on the surface of the cells. In this aspect, the system can be programmed to release a cell from a cell treatment chamber into a channel of the system intersecting with the sensor chamber, thereby exposing a sensor in the sensor chamber to the molecule of interest.

Alternatively, or additionally, when the system is used in conjunction with a cell-based biosensor, the cell treatment chamber can be used to prepare the biosensor itself. In one aspect, a cell is delivered from the treatment chamber to a channel whose outlet intersects with the sensor chamber. In one aspect, the scanning mechanism of the system is used to place a micropositioner in proximity to the outlet so that the micropositioner can position the cell within the sensor chamber. In another aspect, fluid flow or surface tension is used to position a cell in a suitable position. For example, the system can be used to deliver the cell to the opening of a pipette which is part of a patch clamp system.

In another aspect, a cell can be delivered to the sensor chamber to periodically replace a cell-based biosensor in the sensor chamber. In this aspect, the cell can be untreated, e.g., providing a substantially genetically and pharmacologically identical cell (i.e., within the range of normal biological variance) as the previous sensor cell. Alternatively, the replacement cell can be biochemically or genetically manipulated to be different from the previous sensor cell, to enable the system to monitor and correlate differences in biochemical and/or genetic characteristics of the cells with differences in sensor responses. The biochemical or genetic difference can be known or unknown.

The system can be programmed to deliver cells from the cell treatment chamber at selected time periods based on control experiments monitoring uptake of chemicals and molecules by cells. Alternatively, the system can monitor the phenotype of cells and deliver cells when a certain phenotype is expressed. For example, in one aspect, the cell treatment chamber is in communication with an optical sensor which provides information relating to optical properties of the cell to the system processor, and in response to optical parameters indicating expression of a particular phenotype, the system can trigger release of the cell from the cell treatment chamber. Optical parameters can include the uptake of a fluorescent reporter molecule or optical parameters identified in control experiments.

The ability to combine of on-chip electroporation with microfluidics and patch clamp (or other methods for monitoring cell responses) facilitates screening for molecules (e.g., ligands or drugs) which modulate the activity of intracellular targets. In one aspect, the system is used to deliver a cell-impermeant molecule into the interior of a cell by transiently electroporating the cell. In this way, the molecule can be introduced to intracellular receptors, intracellular proteins, transcriptional regulators, and other intracellular targets. The cell can be delivered to the sensor chamber and the response of the cell can be monitored (e.g., by patch clamp or by fluorescence, if the molecule is tagged with a fluorescent label). Alternatively, the sensor chamber can be modified to perform both treatment and response detection.

In a further aspect, the system can be modified to perform electroporation by scanning. For example, a cell can be repeatedly electroporated as it is being translated or scanned across a plurality of different fluid streams containing different compounds. In one aspect, pores are introduced into one or more cells as they come into contact with a sample stream, enabling compounds in the sample stream to be taken up by the cell.

Manipulating Fluid Behavior in Microfluidic Devices

To exploit the unique behaviour of fluid flow into open volumes, the pressure applied to each of a plurality of microchannels can be individually varied for precise manipulation of flow streams from the microchannels into a sensor chamber. For example, in the extreme case in which positive pressure is applied to one channel and negative pressure is applied to an adjacent channel, the fluid stream can be made to make a “U-turn ”, going from the channel with positive pressure to the one with negative pressure while drawing in a sheath of buffer into the channel with negative pressure. Therefore, the position, width, collimation, direction, and rate of flow, as well as the composition of the fluid streams, can be controlled by varying the relative pressure applied to each channel.

As shown in FIGS. 5D-F, this can be used to create a U-shaped fluid stream which has the advantage that sample delivered onto a cell from a channel experiencing positive pressure can be withdrawn into a waste channel experiencing negative pressure. This minimizes the accumulation of ligands in the open volume where the patch-clamped cell resides. In situations where a sample (e.g., a drug, ligand, and the like) is in low concentration and/or is expensive, the system further can be used to recycle ligand and/or to feed ligand back into the system (i.e., the U-shaped stream can be turned into a closed loop).

By controlling pressure, the system can control the velocity (both amplitude and direction) of fluid streams. Velocity control also may be exercised by controlling the resistance of each channel without changing the pressure or by changing both resistance and pressure. Fluid shear also can be varied by using solutions of different viscosity (e.g., adding different amounts of a sugar such as sucrose to a fluid stream) in both the microchannels and sensor chamber. Thus, by varying a number of different parameters, the flow profile of different fluid streams can be precisely tuned.

A two-dimensional microfluidic system is shown in FIGS. 2A-2C. The system comprises a substrate comprising a plurality of microchannels corresponding in number to the number of wells in an industry-standard microtiter plate to which the microchannels will be interfaced, e.g., 96 channels. When the system is used to provide alternating streams of sample and buffer to a sensor, at least 96 sample and 96 buffer microchannels (for a total of at least 192 channels) are provided. Wells of a microtiter plate, or of another suitable container, are coupled to reservoirs which feed sample or buffer to channels, e.g., for the system described previously, the substrate comprises 192 reservoirs, each reservoir connecting to a different channel. Additional reservoirs can be provided for cell storage and delivery, e.g., to provide cells for patch clamp recordings.

In one embodiment, microchannels are substantially parallel, having widths of about 100 μm and thicknesses of about 50 μm. The exact thickness of channels may be varied over a wide range, but preferably is comparable to, or greater than, the diameter of the sensor, e.g., the diameter of a patched cell. For example, inter-channel spacings of about 10 μm may be provided.

Pressure can be applied simultaneously to all microchannels such that a steady state flow of solutions is made to flow through all microchannels at the same rate into the open volume that houses the sensor. In this way, steady state concentrations of different solutions containing ligands or pure buffer can be established at the immediate outlet of each of the microchannels. The width of each microchannel may be adjusted to achieve the desired flow rate in each microchannel.

Although the fluid streams exiting from the parallel channels enter an open volume sensor chamber in the embodiment discussed above, it may be more convenient and desirable to provide a set of parallel drain channels opposite the set of sample and buffer channels. A groove having an appropriate width (e.g., about 50 μm) can be placed in between, and orthogonal to, the two sets of channels (i.e., the delivery and drain channels) to accommodate scanning of a sensor in the sensor chamber. To establish an appropriate flow profile, a negative pressure may be applied to all the drain channels while simultaneously applying a positive pressure to the delivery channels. This induces fluid exiting the delivery channels to enter the set of drain channels.

FIG. 5D shows a three-dimensional microfluidic system. The main difference between this 3D structure and the planar structure shown in FIG. 2B is the displacement along the z axis of fluid flowing between the outlet of the parallel array channels (e.g., interdigitated sample and buffer channels) and the inlet of the waste channels. In this embodiment, a positive pressure is applied to all sample and buffer channels while a negative pressure is simultaneously applied to all waste channels. Consequently, a steady state flow is established between the outlets of the sample/buffer channels and the inlets of the waste channels. In this configuration, a sensor, such as a patch-clamped cell, is scanned across the z-direction flow of fluid, preferably close to the outlet of the sample/buffer microchannels.

Although the fabrication of this 3D structure is more complex than the planar structure, the presence of z-direction flow in many cases will provide better flow profiles (e.g., sharper concentration gradients) across which to scan a sensor, such as a patch-clamped cell. The length over which z-direction flow is established should be significantly greater than the diameter/length of a sensor used. For example, the length of z-direction flow of a cell-based biosensor, such as a patch-clamp cell, should preferably range from about 10 μm to hundreds of μm.

Another strategy for providing alternating sample streams and buffer streams, in addition to scanning, is shown in FIGS. 6A-N. In this embodiment, rather than providing interdigitating outlets which feed sample and buffer, respectively, into the sensor chamber, all outlet streams are sample streams. Buffer superfusion is carried out through one or more capillaries placed in proximity to one or more sensors. In FIG. 5A, the sensor shown is a patch-clamped cell positioned in proximity to an outlet using a patch clamp pipette. A capillary is placed adjacent to the patch clamp pipette and can be used for superfusion, e.g., to resensitize a desensitized cell. By this means, a cell-based biosensor comprising an ion channel can be maintained in a periodically responsive state, i.e., toggled between an ligand non-responsive state (e.g. bound to an agonist when exposed to drugs) and an ligand responsive state (e.g. ligand responsive after superfusion by buffer).

Programmed delivery of buffer through this co-axial or side-capillary arrangement can be pre-set or based on the feedback signal from the sensor (e.g., after signal detection, buffer superfusion can be triggered in response to instructions from the system processor to wash off all bound ligands), providing pulsed delivery of buffer to the sensor. In one aspect, the longitudinal axis of the capillary is at a 900 angle with respect to the longitudinal axis of a patch clamp micropipette, while in another aspect, the longitudinal axis, is less than 90°.

Microchannel outlets themselves also may be arranged in a 3D array (e.g., as shown in FIGS. 5A-F). A 3D arrangement of outlets can increase throughput (e.g., increasing the number of samples that can be screened) and therefore increase the amount of biological information that the sensor can evaluate. In one aspect, the microfluidic system is used to obtain pharmacological information relating to cellular targets, such as ion channels.

There are several advantages to performing HTS in this format over the scanning format described in the preceding paragraphs: (1) ligand exposure time is determined by the inter-superfusion period (e.g., time between pulses of buffer) rather than by the scan speed and width of the ligand streams; (2) buffer superfusion and re-sensitization time also is determined by the duration of the superfusion pulse rather than by residence time in the buffer stream; (3) higher packing density of the number of ligand streams can be provided, thus resulting in the ability to scan a large number of ligands per experiment.

The channel geometry of the microfluidic device is not limiting. In one aspect, a plurality of microchannels converge or feed into the sensor chamber, while in another aspect, a plurality of microchannels converge into a single channel which itself converges into the sensor chamber. The plurality of microchannels can comprise interdigitating channels for sample and buffer delivery respectively. In a preferred aspect, the design is integrated with a patch clamp system. Three exemplary constructions are described below.

i) Planar Radial Spokes-Wheel Format

In this construction, a large number (e.g. 96-1024) of microchannels are arranged as radial spokes which converge into a chamber with dimensions ranging from about 10 μm to about 10 mm which houses the sensor. The number of microchannels used are selected to accommodate the number of sample wells in an industry-standard microtiter plate, e.g., 96 to 1024 wells. In addition to the number of microchannels that matches the number of inputs from the well plates, there are preferably, at least two additional microchannels, one for the delivery of buffer for superfusion/re-sensitization and the other for waste removal.

In order to provide for efficient replacement of fluids contained in the chamber by incoming fluids from the channels, the angle between the input channel and waste channel is optimized. Fluid mixing and replacement is optimal when this angle is about 180° and gets progressively worse as this angle decreases towards 0 degrees. For high flow rates (cm/s to m/s), the effect of this angle becomes progressively more important, while for low flow rates, the angle between the input channel and waste channel is less important.

To maximize efficient replacement of fluids at high flow rates, the number of radial channels can be increased such that each input channel will have a corresponding waste channel, rather than having all input channels share a common waste channel. In this format, all angles between input and output channels are about 180 degrees, ensuring optimal fluid replacement. A second strategy is to construct a three-dimensional radial spokes-wheel channel network, while a third strategy involves the use of branched channel geometries. These strategies are described further below.

One preferred embodiment of a 2D radial spokes-wheel format for rapid solution exchange is shown in FIG. 8. In this embodiment, an array of microchannels is arranged in a spokes-wheel format and converges in a circular sensor chamber at the center.

ii) Three-Dimensional Radial Spokes-Wheel Format

A three-dimensional radial spokes-wheel arrangement also can be used to efficiently replace fluids entering the sensor chamber. In this construction, one or more sensors (e.g., such as cells) are placed on a filter membrane sandwiched between a substrate comprising radial channels and a substrate comprising a waste reservoir. In this format, fluids are forced to flow down from the top layer where the radial channels reside (e.g., through input channels which feed into the radial channels), past the sensor(s), then through the filters and into the waste channel. The filter thus permits the sensor(s) to be superfused with fast fluid flow while supporting the sensors (e.g., such as cells), so they are not carried away or dislodged by the flow. In addition, the fluids are forced to flow past the sensors and to replace all the fluids that surround the sensors.

There are a number of advantages offered by this 3D design: (1) fluids around the cells are completely, efficiently, and rapidly exchanged; (2) sensors, such as cells, are firmly placed on the filter and will not be dislodged by fluid flow even at extremely high flow speed, because in the axial or z-direction, the flow pushes the cells against the filter; and (3) a minimal number of radial channels is required in comparison with the planar radial design described above. The main disadvantage of this design in comparison with other planar designs is increased complexity in the micro-fabrication.

In one preferred embodiment of the 3D radial spokes-wheel format, there is z-direction flow of fluids from the outlets of the microchannels to the inlet of the waste microchannel. Additionally, a porous membrane may be provided, on which the sensor(s) (e.g., cells) are placed. The membrane provides mechanical support for the sensors as the z-direction flow pushes the cell against the membrane. In this embodiment, the arrangements and dimensions of the microchannels are comparable to that of a 2D planar format. Although the fabrication of this 3D structure is more complex than the planar structure, the presence of the z-direction flow in many cases provides better flow profiles, especially for open volume reservoirs. Because the sensors are placed immediately outside (i.e., on top) of the inlet of the waste channels, both ligand streams and superfusion streams are forced to flow past the sensor(s), which result in more efficient and complete dosing of the sensor(s) by the different fluid streams. Also, the presence of the porous membrane support permits the use of higher flow rates and thus higher throughput.

iii) Branched Channel Format

In this design, preferably only two channels are placed directly adjacent to one or more sensors (e.g., such as patch-clamped cells), one for the delivery of compounds and the other for waste. Rather than separating all the input channels and converging the outlets of each input channel so they feed into a center sensor chamber, channels are arranged in a branched geometry. To interface with 96-1024 well plates, the single delivery channel adjacent to the sensor(s) is connected to a multitude of input microchannels, each input channels receiving input from a different well of the 96-1024 well plate. This format has the advantage that the channel delivering compounds and the waste channel can be placed in very close proximity to the sensor(s), thereby ensuring a rapid response from the system. The delivery of the large number of compounds onto the sensor(s) in rapid succession is achieved by the controlled and multiplexed delivery of fluids containing compounds into the single channel feeding directly into the sensor chamber.

One preferred embodiment of this design is shown in FIGS. 9A-C and 10. In this embodiment, a “fish-bone” structure is fabricated with each “bone” corresponding to a sample (e.g., a ligand) delivery microchannel which intersects with a main “spine” microchannel which is connected to a buffer reservoir. The rapid and sequential delivery of sample and buffer onto one or more sensors in a sensor chamber is achieved by first applying a positive pressure to one of the sample delivery microchannels, thus introducing a plug of sample (e.g., such as a ligand) from that microchannel into the main microchannel containing the buffer. This plug is introduced onto the cell by applying positive pressure to the buffer reservoir, which carries the plug onto the sensor, and then washes the sensor (e.g., resensitizing it) with the buffer solution. This cycle of delivery of sample and buffer superfusion is repeated with different samples contained in different microchannels. The layout of this chip design is shown in FIGS. 9A-C. In the embodiment shown in the Figures, the chip can be interfaced with a 96-well plate.

The dimensions (width and thickness) of the microchannel (for both sample delivery and buffer delivery) can be highly variable, with typical dimensions ranging from about 1-100 μm, and preferably from about 10-90 μm. Flow rate also may be varied with preferred flow rates ranging from μm/s to cm/s.

Pressure is isotropic, therefore, upon application of a positive or negative pressure, fluids will flow along any pressure drop without preference to any particular direction. Therefore, preferably, passive one-way valves are integrated at the junction between sample delivery microchannels and the main buffer channel. The purpose of these integrated one-way valves is to prevent any flow from the main buffer channel into each of the sample delivery microchannels upon application of a positive pressure to the buffer reservoir, while allowing flow from each of the sample delivery microchannels into the main buffer channels when positive pressure is applied to reservoirs providing sample to these microchannels. There are numerous suitable designs for microfluidic valves as well as pumping mechanisms.

Although the discussion below emphasizes pressure driven flow owing to its simplicity of implementation, a number of appropriate means can be designed for transporting liquids in microchannels, including but not limited to, pressure-driven flow, electro-osmotic flow, surface-tension driven flow, moving-wall driven flow, thermo-gradient driven flow, ultrasound-induced flow, and shear-driven flow. These techniques are known in the art.

Valving and Pumping.

Scheme 1: Using Septums to Address Individual Microchannels

In this scheme, the reservoirs that connect to each of the microchannels are sealed by a septum, for example, using polydimethyl siloxane (PDMS) for sealing or another suitable material as is known in the art. Because the septum forms an airtight seal, application of a positive pressure (e.g., with air or nitrogen) via a needle or a tube inserted through the septum will cause fluid to flow down the microchannel onto one or more sensors in a sensor chamber (e.g., to the center of a spokes-wheel where radial microchannels converge). Application of a negative pressure with a small suction through the needle or tubing inserted through the septum will cause fluid to be withdrawn in the opposite direction (e.g., from the chamber at the center of the spokes-wheel to the reservoir feeding into the microchannel).

An array of such needle-septum arrangements allows each reservoir to be individually addressed, and therefore, each microchannel. The use of this scheme permits the simultaneous and sequential pumping and valving of the fluids contained within each of the microchannels. By exercising precise control over positive and negative pressure applied to each of the microchannels, controlled fluid flow and compound delivery onto the one or more sensors can be achieved. For designs that do not require individual addressing of the microchannels (e.g., design 1—the rapid transport of patched cells across different streams of fluids), a single or a few septa with a single or a few pressure control devices will suffice.

Scheme 2: Controlling Fluidic Resistance by Varying Channel Dimensions

Although the above design using individual septa offers great flexibility and control, for certain applications in which the sequence of compound delivery and fluid flow is predetermined, a simpler design offers simplicity and ease of implementation. In this scheme, equal positive pressure is applied to all reservoirs, for example, by using pressurized air applied homogeneously to all reservoirs via a single septum, or through the use of gravity flow caused by the difference in height between inlet and outlet reservoirs. The rapid sequential delivery of compounds from each microchannel onto one or more sensors is accomplished by varying the fluidic resistance of each microchannel, which is easily achieved by varying the width and length of the each microchannel.

Fluidic resistance increases linearly with length and to the fourth power of the diameter for a circular capillary. By gradually and systematically varying the dimension of each microchannel, the time delay among the microchannels in their delivery of compounds onto one or more sensors in a sensor chamber can be controlled. This scheme is especially pertinent to high-throughput drug screening applications in which a large number of compounds are to be delivered sequentially and rapidly onto patched cell/cells with pre-determined time delays.

Scheme 3: Control of Fluid Flow with External Valves

In this configuration, compounds from each of the wells of an array well plate are introduced through external tubings or capillaries which are connected to corresponding microchannels. External valves attached to these external tubings or capillaries can be used to control fluid flow. A number of suitable external valves exist, including ones actuated manually, mechanically, electronically, pneumatically, magnetically, fluidically, or by chemical means (e.g., hydrogels).

Scheme 4: Control of Fluid Flow with Internal Valves

Rather than controlling fluid flow with external valves, there are also a number of chip-based valves that can be used. These chip-based valves can be based on some of the same principles used for the external valves, or can be completely different, such as ball valves, bubble valves, electrokinetic valves, diaphragm valves, and one-shot valves. The advantage of using chip-based valves is that they are inherently suited for integration with microfluidic systems. Of particular relevance are passive one-way valves, which are preferred for implementing some of the designs mentioned in above (e.g., such as the branched channel format).

Electroosmotic Transport

Additionally, or alternatively, electroosmosis can be used to produce motion in a stream containing ions, e.g., such as buffer solution, by application of a voltage differential or charge gradient between two or more electrodes. Neutral (uncharged) cells can be carried by the stream. See, e.g., as described in U.S. Published Application No. 20020049389.

Dielectrophoresis is believed to produce movement of dielectric objects, which have no net charge, but have regions that are positively or negatively charged in relation to each other. Alternating, non-homogeneous electric fields in the presence of cells cause the cells to become electrically polarized and thus to experience dielectrophoretic forces. Depending on the dielectric polarizability of the particles and the suspending medium, dielectric particles will move either toward the regions of high field strength or low field strength.

Dieelctrophoresis may be used to control the movement of cells in a microfluidic device. The polarizability of living cells depends on the type of cell and this may provide a basis for cell separation, e.g., by differential dielectrophoretic forces. See, e.g., as described in U.S. Published Application 20020058332. Additionally, cell chambers or sensor chambers can be configured to include one or ore electrical elements for creating an electrical field to aid in positioning cell(s) in proximity to an appropriate electrode compartment, e.g., to create electroosmotic flow within the cell chamber or to polarize a cell to facilitate its movement towards an electrode compartment.

Interfacing Microfluidic Structures with Well Plates

Samples (i.e., drugs, etc.) contained in sample-well plates (e.g., industry-standard microtiter plates such as 96-well plates) are manipulated and transferred, preferably, using robotic automated array pipettors as are known in the art (for example, Beckman's Biomek 1000 & 2000 automated workstations, available from Beckman Coulter, Inc., Fullerton, Calif.).

To be able to leverage the same sample transfer platform used to array a sample in a well plate, one important design parameter is to ensure the reservoir arrangements in microfluidic device described above are compatible for use with such array pipettors. For example, preferably, the reservoirs in the microfluidic chip are arranged such that the center-to-center distance between each reservoir is identical to the center-to-center distance between each well of the well plate to which the chip interfaced. Preferably, each reservoir has a diameter suitable for receiving a fluid stream from an array pipettor without significantly impeding the flow of fluid from the array pipettor.

In addition to array pipettors, there are other suitable automated devices for transferring samples from well plates onto chips, such as robotic sequential pipettors. It is important to note that the use of these other devices may permit more flexible placement of reservoirs and microchannels on the chip, providing more flexibility in the design of channel parameters. Although a substrate suitable for interfacing between 96-well array pipettors is described in more detail below owing to the widespread use of these pipettors, it should be obvious to those of skill in the art that the general design of the chip and placement of reservoirs can be modified for interfacing with any desirable sample transfer platform, as such platforms evolve. In general, reference to 96-well plates is not intended to be limiting.

MEMS Devices

In one aspect of the invention, the microscale device interfaced with the macroscale device is an Micro-Electro-Mechanical System (MEMS). MEMS devices integrate one or more of mechanical elements, sensors, actuators, and electronics on a common silicon substrate through the utilization of microfabrication technology. Electronics can be fabricated on the substrates of such devices using integrated circuit (IC) process sequences (e.g., CMOS, Bipolar, or BICMOS processes) while the micromechanical components can be fabricated using micromachining processes that selectively etch away parts of the silicon wafer or add new structural layers to form the mechanical components of the device.

MEMS devices are versatile in application and can also include microfluidic elements (e.g., microchannels for fluid flow). MEMS devices include but are not limited to switches, piezoresistive pressure sensor integrated circuits, custom micromachined microstructures, hybrid pressure sensor assemblies, sesnors to measure humidity and vapor pressure, electrostatic and electromagnetic actuators, bi-stable devices, H-Q inductors, variable capacitors, tunable filters, gene chips, drug delivery chips and the like.

Other microscale devices will be obvious in view of the disclosure herein and are encompassed within the scope of the invention.

Macroscale Components

In one aspect, the invention provides an integrated system comprising macroscale and microscale components. Macroscale components include, but are not limited to: a pump head; pump (e.g. diaphragm, piston, bellows, etc.); degasser; flow meter; injector manifold, such as an injector valve; a pressure sensor; flow cell; concentration manifolds or cartridges; fittings (e g. tees, unions, bulkhead unions, expanders, reducers, fittings to provide an orifice for a pressure drop, etc.); a mixer (e.g., static, active, ultrasonic, etc.); an injector; a compressor (e.g. centrifugal, bellows, pistons, etc.); an ultrasonic bed; an extractor (e.g. liquid-liquid, gas-liquid, gas-gas, solid-liquid, etc.); a Dynamic Field Gradient Focusing (DFGF) device; a dialysis chamber; an absorption chamber; a metabolite chamber (e.g. for monitoring molecular changes); a toxicity chamber (e.g. for monitoring a response to toxins or the by-products of drug metabolism); a cell chamber and the like.

In one aspect, the macroscale component is a detector, such as a UV/Visible absorbance flow cell; a fluorescence flow cell; a conductivity flow cell; an electrochemical detector (e.g. amperometric, cyclic voltammetry, etc.); a plasma detector; a mass spectrometry detector (e.g. electrospray MS source, quadrapole MS, partMe beam MS source, glowdischarge MS source, chemical ionization MS source, plasma MS source, micro-Ion trap, electrospray plus micro-Ion trap, or time-of flight MS detector), and the like. The detector can be a sensor, such as a flow meter, a pressure transducer, a temperature sensor (e.g. thermocouple, resistance temperature detector (RTD)), a chemical sensor (e.g., for sensing parameters such as pH, O₂, CO₂, salinity, conductivity, nitrate, phosphate, etc.), a capillary electrophoresis sensor, an acoustic sensor, a color sensor, an optical sensor, a bar code sensor, a photothermal sensor, a photoacoustic sensor, an RFID tags, and the like.

Additionally, macroscale components can comprise reagent vessels, cell chambers, sensor chambers, separation columns (e.g., LC, CE, MEKC, etc.); iso-electric focusing columns; size-exclusion columns; ion-exchange columns; affinity columns; solid-phase extraction beds; filters; sieves; frits; a depth filter (e.g., such as a channel stepped at increasing or decreasing depths); and reactors, such as distillers, vaporizers, cocurrent or countercurrent extraction or reaction beds, heaters, heat exchangers, and coolers; magnetic field generators; electric field generators; electroporation devices, patch clamp pipettes, and the like.

In one aspect, a macroscale component comprises a fluid source for delivering a fluid stream to a sensor chamber in a microfluidic device. The fluid source may interface with one or more microchannels in the device or comprise one or more outlets for delivering fluid directly into the cell chamber. Preferably, the fluid source provides a plurality of substantially separate fluid streams to the sensor chamber, allowing the solution environment around the sensor to be rapidly changed. In one aspect, the fluid source comprises a plurality of stacked microfluidic chips comprising parallel microchannels in register with one another, with at least one inlet of a microchannel in communication with a pump device.

In another aspect, a microscale device is interfaced with a medical device such as a catheter, endoscope, optical probe for imaging a body lumen, a drug delivery device, a pacemaker and the like.

In a further aspect, a plurality of microscale devices may be interfaced to one another, e.g., stacked or otherwise connected. For example, a plurality of microscale devices can be interfaced to create a macroscale device.

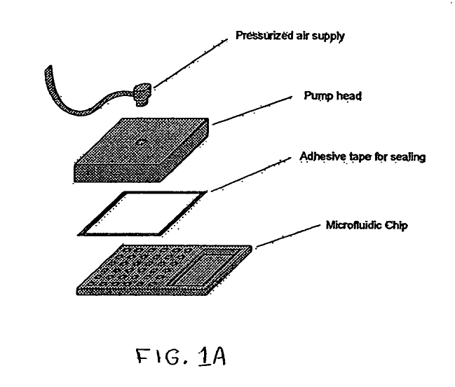

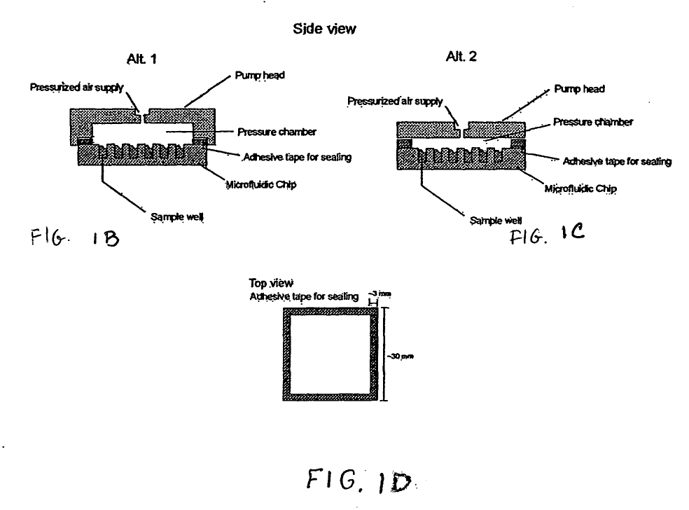

In a particularly preferred embodiment, the microscale device is interfaced with a macroscale device comprising a pump head connectable to a pressurized air supply. See, e.g., FIGS. 1A-1B.

Interfacing Macroscale Components with Microscale Components

In a preferred aspect of the invention at least a portion of a macroscale device is interfaced to a microscale device (e.g., such as a microfluidics device or MEMS device) using a double-sided adhesive tape of a size sufficient to form a stable association between the microscale device and the macroscale device. As used herein, a “stable association” is one that provides a suitable functional interface between the macroscale device and the microscale device. For example, a preferred functional interface is one which does not substantially disturb fluid flow within the device, maintains a suitable pressure at the interface, is relatively inert to reagents, detergents, salts, has a neutral pH, can adhere at low temperatures, has good water and moisture resistance, load bearing capacity, and/or is able to maintain an electrical connection with a macroscale device.

In one aspect, a suitable tape for interfacing a macroscale component to a microscale component comprises a backing coated at least partially on both sides with an adhesive. The backing may be a nonwoven paper, polymeric film (e.g., polypropylene (e.g., biaxially oriented polypropylene (BOPP)), polyethylene, polyurea, or polyester (e.g., polyethylene terephthalate (PET)). Generally, the composition of the backing is non-limiting; however backings are preferably less than about 100 μm thick, more preferably, less than about 50 μm, or less than about 10 μm thick.

Preferably, at least one surface of the backing is coated at least partially with a pressure sensitive adhesive. More preferably, such an adhesive has a permanent tack, adheres with no more than finger pressure, has sufficient ability to form a stable association with a macroscale and microscale component (e.g., for at least about one week, preferably for at least about one month, and more preferably, for greater than about six months). In one aspect, peel adhesion to a surface of either component is about 100 N/dm².

Suitable adhesives include, but are not limited to polymers such as natural rubber, synthetic rubber—(e.g., styrene/butadiene copolymers (SBR) and styrene/isoprene/styrene (SIS) block copolymers), and various (meth)acrylate—(e.g., acrylate and methacrylate) based polymers. Any suitable (meth)acrylate (i.e. acrylate or methacrylate) polymer can be used. (Meth)acrylate polymers are those derived from at least one (meth)acrylate monomer. (Meth)acrylate polymers may also be derived from, for example, other ethylenically unsaturated monomers and/or acidic monomers and/or the (meth)acrylate polymers may also be grafted with a reinforcing polymeric moiety.

Particularly preferred (meth)acrylate monomers include (meth)acrylate esters of non-tertiary alkyl alcohols, the alkyl groups of which comprise from about 1 to about 18 carbon atoms, preferably about 4 to about 12 carbon atoms, and mixtures thereof. Examples of suitable (meth)acrylate monomers useful in the present invention include, but are not limited to, methyl acrylate, ethyl acrylate, methyl methacrylate, ethyl methacrylate, n-butyl acrylate, decyl acrylate, 2-ethylhexyl acrylate, 2-ethylhexyl methacrylate, hexyl acrylate, isoamyl acrylate, isodecyl acrylate, isodecyl methacrylate, isononyl acrylate, isooctyl acrylate, lauryl acrylate, 2-methylbutyl acrylate, 4-methyl-2-pentyl acrylate, ethoxyethoxyethyl acrylate, isobornyl acrylate, isobornyl methacrylate, 4-t-butylcyclohexyl methacrylate, cyclohexyl methacrylate, phenyl acrylate, phenyl methacrylate, 2-naphthyl acrylate, 2-naphthyl methacrylate, and mixtures thereof Particularly preferred are 2-ethylhexyl acryl ate, isooctyl acrylate, lauryl acryl ate, n-butyl acrylate, ethoxyethoxyethyl acrylate, and mixtures thereof.

Examples of other ethylenically unsaturated monomers include, but are not limited to, vinyl esters (e.g., vinyl acetate, vinyl pivalate, and vinyl neononanoate); vinyl amides; N-vinyl lactams (e.g., N-vinyl pyrrolidone and N-vinyl caprolactam); (meth)acrylamides (e.g., N,N-dimethyl acrylamide, N,N-dimethyl methacrylamide, N,N-diethyl acrylamide, and N,N-diethyl methacrylamide); (meth)acrylonitrile; maleic anhydride; styrene and substituted styrene derivatives (e.g., alpha-methyl styrene); and mixtures thereof.

Acidic monomers may also be used for preparation of the (meth)acrylate polymers. Useful acidic monomers include but are not limited to, those selected from ethylenically unsaturated carboxylic acids, ethylenically unsaturated sulfonic acids, ethylenically unsaturated phosphonic acids, and mixtures thereof. Examples of such compounds include, but are not limited to, acrylic acid, methacrylic acid, itaconic acid, fumaric acid, crotonic acid, citraconic acid, maleic acid, beta-carboxyethyl acrylate, 2-sulfoethyl methacrylate, styrene sulfonic acid, 2-acrylamide-2-methylpropane sulfonic acid, vinyl phosphonic acid, and the like, and mixtures thereof.

A suitable class of useful (meth)acrylate polymers is described in U.S. Pat. No. 4,554,324. This patent discloses reinforcement of conventional (meth)acrylate polymers by modification of the (meth)acrylate polymeric backbone by grafting reinforcing polymeric moieties onto the (meth)acrylate polymeric backbone. The reinforcing polymeric moieties may be grafted, for example, by in-situ polymerization of the reinforcing polymeric moieties in the presence of and onto reactive sites of the ungrafted (meth)acrylate polymer backbone, reacting prepolymerized polymeric moieties with reactive sites of the ungrafted (meth)acrylate polymer backbone, or by copolymerizing reinforcing polymeric compounds with monomer used to prepare the (meth)acrylate polymer backbone to form the (meth)acrylate polymer grafted with reinforcing polymeric moieties.

In one aspect, a PSA comprises a mixture of acrylics and poly alpha-olefins. A suitable adhesive can comprise 5 to 95 weight percent of an acrylic PSA and about 5 to about 95 weight percent of a thermoplastic elastomeric copolymer. Useful thermoplastic elastomeric materials include styrene-(ethylene-propylene) block copolymers, polyolefin-based thermoplastic elastomeric materials represented by the formula —(CH₂CHR)x, where R is an alkyl group containing 2 to 10 carbon atoms, and polyolefins based on metallocene catalysis, such as an ethylene/1-octene copolymer.

Preferably, the (meth)acrylate polymer component is present in at least about 15 weight % based on total weight of the (meth)acrylate polymer and propylene-derived polymer components. Preferably, the (meth)acrylate polymer component is present in at least about 20 weight %, more preferably about 20 weight % to about 50 weight %, based on total weight of the (meth)acrylate polymer and propylene-derived polymer components.

The propylene-derived polymer is derived from at least propylene monomer. While other types of monomers may be used in their preparation, typically the propylene-derived polymer is derived from greater than 60 mole percent propylene monomers. Other monomers that can be copolymerized with the propylene monomer include, for example, alpha-olefin monomers (e.g., ethylene, 1-butene, 1-hexene, 1-heptene, 1-octene, 1-nonene, etc.). Preferably, propylene-derived polymers contain a saturated hydrocarbon backbone. Preferably, the weight average molecular weight of the propylene-derived polymer is at least about 10,000 grams/mole, even more preferably at least about 15,000 grams/mole, and even more preferably at least about 20,000 grams/mole. Particularly useful are polymers with a weight average molecular weight of about 10,000-1,000,000 grams/mole, preferably about 20,000-200,000 grams/mole.

According to one aspect of the invention, the propylene-derived polymer is a copolymer derived from at least propylene and ethylene monomer.

According to another aspect of the invention, the propylene-derived polymer is derived from essentially 100 percent by weight propylene monomers. Any suitable polypropylene can be used in accordance with this aspect of the invention. Generally, the higher the melt viscosity of the propylene-derived polymer, the more likely it is that the resulting composition will have a higher shear strength in conjunction with improved peel adhesion properties. Preferably, the propylene-derived polymer component is present in at least about 20 weight %, more preferably about 20 weight % to about 50 weight %, based on total weight of the (meth)acrylate polymer and propylene-derived polymer components.

PSAs may comprise one or more tackifiers. Other additives (e.g., antioxidants, crosslinking additives, fillers, and ultraviolet stabilizers) may also be added to the PSA compositions, depending on the desired application and as well known to one of ordinary skill in the art.

PSAs are described, for example in: European Patent Application No. 0 254 002; U.S. Pat. No. 5,202,361, and WO 97/23,577 (Minnesota Mining and Manufacturing Co.). PSA blends are particularly useful for adhering to both relatively high energy surface materials (e.g., such as glass) and low surface energy materials (e.g., such as polypropylene).

The PSA may be crosslinked to further improve the shear strength of the PSA. Any suitable crosslinking method (e.g., exposure to radiation, such as actinic (e.g., ultraviolet or electron beam) or thermal radiation) or crosslinker additive (e.g., including photoactivated and thermally activated curatives) may be utilized.

A general description of useful pressure sensitive adhesives may be found in Encyclopedia of Polymer Science and Engineering, Vol. 13, Wiley-Interscience Publishers (New York, 1988).

In another aspect, the tape comprises a stretch releasing tape which comprises at least a portion in a compressed state and another portion in an uncompressed state. The portion which is uncompressed can act as a pull tab. The uncompressed portion can include one or more raised portions, non-planar surfaces or a discontinuous surface. The pull tab may be used to facilite manipulation of the macroscale and microscale devices.

In one aspect, one or more of the surfaces of the backing is uniformly coated with adhesive. However, in another aspect, the backing comprises segments or stripes of adhesive.

In another aspect, the adhesive can adhere to a substrate that has been at least partially exposed to a fluid, such as water. Such adhesives may comprise at least one monofunctional unsaturated monomer selected from the group consisting of (meth)acrylate esters of non-tertiary alkyl alcohols. The alkyl groups preferably have from about 4 to 12, more preferably about 4 to 8 carbon atoms. Examples of suitable (meth)acrylate monomers include, but are not limited to, n-butyl acrylate, decyl acrylate, 2-ethylhexyl acrylate, hexyl acrylate, isoamyl acrylate, isodecyl acrylate, isononyl acrylate, isooctyl acrylate, lauryl acrylate, 2-methyl butyl acrylate, 4-methyl-2-pentyl acrylate, ethoxy ethoxyethyl acrylate, and mixtures thereof Particularly preferred are N-butyl acrylate, 2-ethylhexyl acrylate, isooctyl acrylate, lauryl acrylate, and mixtures thereof. Such adhesives also preferably comprise hydrophilic acidic comonomers that include, but are not limited to, those selected from ethylenically unsaturated carboxylic acids, ethylenically unsaturated sulfonic acids, ethylenically unsaturated phosphonic acids, and mixtures thereof. Examples of such compounds include those selected from acrylic acid, methacrylic acid, itaconic acid, fumaric acid, crotonic acid, citraconic acid, maleic acid, β-carboxyethyl acrylate, 2-sulfoethyl methacrylate, styrene sulfonic acid, 2-acrylamido-2-methylpropane sulfonic acid, vinyl phosphonic acid, and the like, and mixtures thereof. Particularly preferred hydrophilic acidic monomers are the ethylenically unsaturated carboxylic acids, most preferably acrylic acid.

Additional components include, but are not limited to, minor amounts (e.g., less than 5% and preferably, less than 1% of monomers copolymerizable with the (meth)acrylate monomers and hydrophilic acidic monomers. Examples of such monomers include (meth)acrylamides, vinyl esters, and N-vinyl lactams.

The copolymerizable mixture comprises, based upon 100 parts by weight total, about 30 to 70, preferably 35 to 65, more preferably about 40 to 60 parts by weight of at least one (meth)acrylate monomer and about 70 to 30, preferably about 65 to 35, more preferably about 60 to 40 parts by weight of a hydrophilic acidic monomer.

The adhesive may additionally comprise one or more plasticizing agents which serve as a polymerization medium for the co-reactants. Particularly useful plasticizing agents include polyalkylene oxides having weight average molecular weights of about 150 to 5,000, preferably of about 150 to 1,500, such as polyethylene oxides, polypropylene oxides, polyethylene glycols; alkyl or aryl functionalized polyalkylene oxides, such as PYCAL 94 (a phenyl ether of polyethylene oxide, commercially available from ICI Chemicals); benzoyl functionalized polyethers, such as Benzoflex 400 (polypropylene glycol dibenzoate, commercially available from Velsicol Chemicals) and monomethyl ethers of polyethylene oxides, and mixtures thereof.

The plasticizing agent can be used in amounts from about 10 to 100 pph, preferably about 30 to 100 pph (parts by weight per 100 parts of the (meth)acrylate monomers and hydrophilic acidic comonomers). The amount of plasticizer used depends upon the type and ratios of the (meth)acrylate monomers and hydrophilic acidic monomers used in the polymerizable mixture and the chemical class and molecular weight of the plasticizing agent used

Other suitable adhesives include but are not limited to: those based on general compositions of polyacrylate; polyvinyl ether; diene rubber such as natural rubber, polyisoprene, and polybutadiene; polyisobutylene; polychloroprene; butyl rubber; butadiene-acrylonitrile polymer; thermoplastic elastomer; block copolymers such as styrene-isoprene and styrene-isoprene-styrene (SIS) block copolymers, ethylene-propylene-diene polymers, and styrene-butadiene polymers; polyalpha-olefin; amorphous polyolefin; silicone; ethylene-containing copolymer such as ethylene vinyl acetate, ethylacrylate, and ethyl methacrylate; polyurethane; polyamide; epoxy; polyvinylpyrrolidone and vinylpyrrolidone copolymers; polyesters; and mixtures or can contain additives such as tackifiers, plasticizers, fillers, antioxidants, stabilizers, pigments, diffusing materials, curatives, fibers, filaments, and solvents.

In one aspect, the adhesive on one side of the tape is different from the adhesive on the other side of the tape to maximize adhesion to the different surfaces of the macroscale device and microscale device respectively.

In another aspect, the tape is patterned, i.e., comprising different types of adhesive at different portions of the tape. In a further aspect, the tape comprises portions that do not comprise an adhesive layer. For example, the adhesive may be laid down in the form of a pattern such that bonding occurs at discrete locations on the surface of a microscale or macroscale device.

Additional layers can be added to the adhesive layer. For example, primer layers may be added to increase adhesion of an adhesive layer to the backing layer. However, preferably, the thickness of the adhesive layer is less than about 500 μm, less than about 250 μm, 100 μm, less than about 75 μm, less than about 50 μm, less than about 25 μm, less than about 10 μm or less than about 5 μm.

In one aspect, an adhesive is selected which is heat activated. An adhesive may be solvent- or water-free or solvent- or water-based.

In another aspect, the adhesive is electrically conductive or thermally conductive.

Preferably, at least one side of the adhesive-coated backing comprises a release liner that can be pulled away from the tape to expose the adhesive for interfacing with a microscale or mesoscale device. The base paper of the release liner may be selected from krafts, super-calendered krafts, clay coated krafts, glassines, parchments, and other papers and films which have a suitable undercoating for release coating hold-out. The release coating may be any of the known materials used for their release properties for adhesives. Preferred types are silicones and modified silicones, the modification including both copolymerization of silicones with other nonrelease chemical agents or by adding nonsilicone materials to the silicone coating solution prior to application to the release base paper. Other release agents such as polyethylene, fluorocarbons, Werner-type chromium complexes, and polyvinyl octadecyl carbamate may also be used. The choice of release coating is dependent on the tack, adhesion level, and chemical nature of the adhesive layer as is known in the art.

Suitable double-sided tapes can be readily manufactured using means well known in the art. However, double-sided tapes for use in the invention are also commercially available, e.g., from the 3M™ Innovative Properties Company (St. Paul, Minn.). Types of tapes may be selected according to the properties of the surfaces of the macroscale and microscale devices and according to the functionality desired at the interface (e.g., one or more of heat resistance, electrical conductivity, solvent resistance, moisture resistance, uv resistance, and the like). (e.g., by using the Interactive User Interface of 3M™, accessible at http://www.3m.com/us/index.jhtml. Preferably, the tape is suitable for die cutting and does not require heat to apply.

In some aspects, rather than a double-sided tape, a transfer tape is used which transfers adhesive to a surface. For example, an adhesive can be separably attached to a backing so that the bond between the adhesive and the backing is weaker than a subsequent bond between the adhesive and a macroscale or microscale surface. This can be achieved by including a release coating on one or both surfaces of the backing. A release liner covers the adhesive until it is ready for use and preferably, the release coating on the release layer has a weaker bond with the adhesive than the release coating on the backing, so that the release liner may be rolled away from the adhesive.

Adhesive is transferred to the macroscale or microscale surface by adhering the tape to the macroscale or microscale surface rolling away the release liner, and then removing the backing, leaving only the adhesive on the macroscale or microscale surface. The exposed transfer adhesive on the macroscale/microscale surface is then available to bond to a microscale/macroscale surface. Transfer tapes are described in U.S. Pat. No. 6,455,152, U.S. Pat. No. 6,407,195, and U.S. Pat. No. 6,352,766, for example.

Useful release liners include those that are suitable for use with silicone adhesives and organic pressure-sensitive adhesives. Useful release liner release coating compositions are described in, for example, EP 378,420, U.S. Pat. No. 4,889,753, EP No. 311,262. Commercially available release coating compositions include SYL-OFF™ Q2-7785 fluorosilicone release coating, available from Dow Corning Corp., Midland, Mich.; X-70-029HS fluorosilicone release coating, available from Shin-Etsu Silicones of America, Torrance, Calif.; S TAKE-OFF™ 2402 fluorosilicone release liner from Release International, Bedford Park, Ill., and the like.

The use of transfer tapes may be desirable when surfaces are irregular and/or to minimize the size of the integrated device comprising the macroscale and microscale device.

Tape is preferably die cut using means known in the art to provide a suitably sized adhesive area on a macroscale or microscale surface. Preferably, gentle pressure is all that is needed to join the macroscale and microscale device at the adhesive surface, although less preferably, heat may be used.

Variations, modifications, and other implementations of what is described herein will occur to those of ordinary skill in the art without departing from the spirit and scope of the invention.

All of the references, patents, patent applications, patent publications, and international applications identified hereinabove are hereby expressly incorporated herein by reference in their entireties. What is claimed is:

1. A method for interfacing a macroscale device with a microscale device, comprising:
providing a macroscale device;
providing a microscale device;
providing a double-sided tape comprising a backing with a first and second side, each side coated at least partially with an adhesive to thereby generate a first and second adhesive surface, respectively;
adhering the first adhesive surface to a macroscale device surface to be interfaced with a microscale device surface,
contacting the microscale device surface to the second adhesive, thereby interfacing the macroscale device with the microscale device.

2. A method for interfacing a macroscale device with a microscale device, comprising:
providing a macroscale device;
providing a microscale device;
providing a double-sided tape comprising a backing with a first and second side, each side coated at least partially with an adhesive to thereby generate a first and second adhesive surface, respectively;
adhering the first adhesive surface to a microscale device surface to be interfaced with a macroscale device surface,
contacting the macroscale device surface to the second adhesive, thereby interfacing the macroscale device with the microscale device.

3. A method for interfacing a macroscale device with a microscale device, comprising:
providing a macroscale device;
providing a microscale device;
providing a transfer tape comprising a backing to which an adhesive surface is separably attached and wherein the bond between the adhesive and backing is weaker than a bond to be formed between the adhesive and a macroscale device surface or microscale device surface;
adhering the adhesive surface to the macroscale device surface;
removing the backing; and
contacting the microscale device surface to the adhesive adhered to the macroscale surface; thereby interfacing the macroscale device with the microscale device.

4. A method for interfacing a macroscale device with a microscale device, comprising:
providing a macroscale device;
providing a microscale device;
providing a transfer tape comprising a backing to which an adhesive surface is separably attached and wherein the bond between the adhesive and backing is weaker than a bond to be formed between the adhesive and a macroscale device surface or microscale device surface;
adhering the adhesive surface to the microscale device surface;
removing the backing; and
contacting the macroscale device surface to the adhesive adhered to the microscale surface; thereby interfacing the macroscale device with the microscale device.

5. The method according to any one of claims 1-4, wherein the microscale device is a microfluidic device.

6. The method according to any one of claims 1-4, wherein the microscale device is an MEMS device.

7. The method according to claim 5, wherein the microfluidic device comprises at least one microchannel.

8. The method according to claim 5, wherein the microfluidic device comprises a plurality of microchannels.

9. The method according to claim 5, wherein the microchannels correspond in number to the number of wells in an industry-standard microtiter plate.

10. The method according to claim 9, wherein the microchannels connect to reservoirs in the microfluidic device and wherein the center-to-center distance of each reservoir corresponds to the center-to-center distance of the wells in the industry-standard microtiter plate.

11. The method according to claim 5, wherein the microfluidic device further comprises a sensor chamber for containing a sensor.

12. The method according to claim 11, wherein the sensor chamber is for containing one or more cells.

13. The method according to claim 5, wherein microfluidic device comprises at least one electrical element for performing planar patch clamp analysis.

14. The method according to any of claims 1-4, wherein the macroscale device is a medical device.

15. The method according to any of claims 1-4, wherein the macroscale device comprises a pump head connectable to a pressurized air supply.

16. The method according to any one of claims 1-4, wherein the macroscale surface is a surface of a device selected from the group consisting of a pump head, pump, degasser, flow meter, injector manifold, a pressure sensor; flow cell; concentration manifold or cartridges; a fitting or connector, a mixer, a compressor, an ultrasonic bed, an extractor, a focusing device, a dialysis chamber, an absorption chamber, a metabolite chamber, a toxicity chamber, a cell chamber, a detector, an RFID tag, a reagent vessel, a separation column, a focusing column, a size exclusion column, an ion-exchange columns; affinity columns; solid-phase extraction beds; a filter; a sieve; a frit; a depth filter, a heater, a heat exchanger, a cooler; a magnetic field generator; electric field generator; electroporation device, patch clamp pipette, and one or more connections thereto.

17. The method according to claim 16, wherein the detector is selected from the group consisting of a UV/Visible absorbance flow cell, a fluorescence flow cell, a conductivity flow cell, an electrochemical detector, a plasma detector, surface plasmon resonance detector and a mass spectrometry detector.

18. The method according to claim 16, wherein the detector is a sensor selected from the group consisting of a flow meter, a pressure transducer, a temperature sensor, a chemical sensor, an acoustic sensor, a color sensor, an optical sensor, a bar code sensor, a photothermal sensor, a photoacoustic sensor, and an RFID tag.

19. The method according to claim 1 or 2, wherein at least one adhesive surface is covered by a release liner prior to adhering the device surface of the macroscale or microscale device.

20. The method according to claim 3 or 4, wherein the backing comprises a release coating for facilitating release of the adhesive from the backing.

21. The method according to claim 1 or 2 wherein the first adhesive and second adhesive comprise different types of adhesive.

22. The method according to any of claims 1-4, wherein the adhesive is patterned onto the backing.

23. The method according to claim 1 or 2, wherein at least one surface of the backing comprises portions that are coated with adhesive and portions that are not coated with adhesive.

24. The method according to any of claims 1-4, further comprising cutting the tape to a shape which is substantially the same size and/or shape as the surface of the macroscale device or microscale device to be interfaced.

25. The method according to claim 24, wherein cutting is performed using a die-cutting machine.

26. The method according to any of claims 1-4 where the tape can conduct heat.

27. The method according to any of claims 1-4 wherein the tape is electrically conducting.

28. A system comprising a macroscale device which is interfaced with a microscale device at an interface using double-sided tape.

29. A system comprising a macroscale device which is interfaced with a microscale device at an interface using transfer tape.

30. The system according to claim 28 or 29, wherein the microscale device is a microfluidic device.

31. The system according to claim 28 or 29, wherein the microscale device is a MEMS device.

32. The system according to claim 30, wherein the microfluidic device comprises at least one microchannel.

33. The system according to claim 30, wherein the microfluidic device comprises a plurality of microchannels.

34. The system according to claim 30, wherein the microchannels correspond in number to the number of wells in an industry-standard microtiter plate.

35. The system according to claim 34, wherein the microchannels connect to reservoirs in the microfluidic device and wherein the center-to-center distance of each reservoir corresponds to the center-to-center distance of the wells in the industry-standard microtiter plate.

36. The system according to claim 30, wherein the microfluidic device further comprises one or more sensor chambers for containing one or more sensors.

37. The system according to claim 36, wherein the one or more sensor chambers is for containing one or more cells.

38. The system according to claim 30, wherein microfluidic device comprises at least one electrical element for performing planar patch clamp analysis.

39. The system according to claim 28 or 29, wherein the microfluidic device is a MEMS device.

40. The method according to claim 28 or 29, wherein the macroscale device comprises a pump head connectable to a pressurized air supply.

41. The method according to claim 28 or 29, wherein the macroscale surface interfaced with a microscale surface is a surface of a device selected from the group consisting of a pump head, pump, degasser, flow meter, injector manifold, a pressure sensor; flow cell; concentration manifold or cartridges; a fitting or connector, a mixer, a compressor, an ultrasonic bed, an extractor, a focusing device, a dialysis chamber, an absorption chamber, a metabolite chamber, a toxicity chamber, a cell chamber, a detector, an RFID tag, a reagent vessel, a separation column, a focusing column, a size exclusion column, an ion-exchange columns; affinity columns; solid-phase extraction beds; a filter; a sieve; a frit; a depth filter, a heater, a heat exchanger, a cooler; a magnetic field generator; electric field generator; electroporation device, patch clamp pipette, and one or more connections thereto.

42. The system according to claim 41, wherein the detector is selected from the group consisting of a UV/Visible absorbance flow cell, a fluorescence flow cell, a conductivity flow cell, an electrochemical detector, a plasma detector, surface plasmon resonance detector and a mass spectrometry detector,

43. The system according to claim 41, wherein the detector is a sensor selected from the group consisting of a flow meter, a pressure transducer, a temperature sensor, a chemical sensor, an acoustic sensor, a color sensor, an optical sensor, a bar code sensor, a photothermal sensor, a photoacoustic sensor, and an RFID tag.

44. The system according to claim 28 or 29, wherein at least one adhesive side of the tape surface is covered by a release liner prior to adhering the device surface of the macroscale or microscale device.

45. The system according to claim 28 wherein adhesives on each side of the double sided tape comprise different types of adhesive.

46. The system according to claim 28 or 29, wherein the adhesive on the tape is patterned onto a backing.

47. The system according to claim 28 or 29, wherein at least one surface of the tape comprises portions that are coated with adhesive and portions that are not coated with adhesive.
